(19) United States
(12) Patent Application Publication
(10) Pub. No.: US 2018/0076481 A1
(43) Pub. Date: Mar. 15, 2018

(54) SOLID ELECTROLYTE COMPOSITION, MIXTURE, COMPLEXED GEL, ELECTRODE SHEET FOR ALL-SOLID STATE SECONDARY BATTERY, ALL-SOLID STATE SECONDARY BATTERY, AND METHODS FOR MANUFACTURING SOLID ELECTROLYTE COMPOSITION, COMPLEXED GEL, ELECTRODE SHEET FOR ALL-SOLID STATE SECONDARY BATTERY AND ALL-SOLID STATE SECONDARY BATTERY

(71) Applicant: FUJIFILM Corporation, Tokyo (JP)

(72) Inventors: Masaomi MAKINO, Ashigarakami-gun (JP); Hiroaki MOCHIZUKI, Ashigarakami-gun (JP); Tomonori MIMURA, Ashigarakami-gun (JP); Katsuhiko MEGURO, Ashigarakami-gun (JP)

(73) Assignee: FUJIFILM Corporation, Tokyo (JP)

(21) Appl. No.: 15/814,822

(22) Filed: Nov. 16, 2017

Related U.S. Application Data
(63) Continuation of application No. PCT/JP2016/065311, filed on May 24, 2016.

(30) Foreign Application Priority Data
May 28, 2015 (JP) 2015-108513
Nov. 19, 2015 (JP) 2015-226395

(51) Int. Cl. H01M 10/0565; C08J 3/09; C08L 77/06; C08L 75/02

(52) U.S. Cl. CPC H01M 10/0565; C08J 3/092; C08L 2203/20; C08L 75/02; C08L 77/06

(57) ABSTRACT

Provided are a solid electrolyte composition containing a low-molecular-weight gellant, an inorganic solid electrolyte having conductivity of ions of metals belonging to Group I or II of the periodic table, and a dispersion medium, a mixture, complexed gel, an electrode sheet for an all-solid state secondary battery, and an all-solid state secondary battery for which the solid electrolyte composition, the mixture, and the complexed gel are used, and methods for manufacturing an all-solid state secondary battery, complexed gel, an electrode sheet for an all-solid state secondary battery, and an all-solid state secondary battery.

### CROSS-REFERENCE TO RELATED APPLICATIONS

This application is a Continuation of PCT International Application No. PCT/JP2016/065311 filed on May 24, 2016, which claims priorities under 35 U.S.C. § 119 (a) to Japanese Patent Application No. 2015-108513 filed on May 28, 2015, and to Japanese Patent Application No. 2015-226395 filed on Nov. 19, 2015. Each of the above applications is hereby expressly incorporated by reference, in its entirety, into the present application.

### BACKGROUND OF THE INVENTION

### 1. Field of the Invention

The present invention relates to a solid electrolyte composition, a mixture, complexed gel, an electrode sheet for an all-solid state secondary battery, an all-solid state secondary battery, and methods for manufacturing a solid electrolyte composition, complexed gel, an electrode sheet for an all-solid state secondary battery, and an all-solid state secondary battery.

### 2. Description of the Related Art

For lithium ion batteries, electrolytic solutions have been used. Attempts are underway to produce all-solid state secondary batteries in which all constituent materials are solid by replacing electrolytic solutions with solid electrolytes. Reliability in terms of all performance of batteries is an advantage of techniques of using inorganic solid electrolytes. For example, to electrolytic solutions being used for lithium ion secondary batteries, flammable materials such as carbonate-based solvents are applied as media. In spite of the employment of a variety of safety measures, there may be a concern that disadvantages may be caused during overcharging and the like, and there is a demand for additional efforts. All-solid state secondary batteries in which non-flammable electrolytes can be used are considered as a fundamental solution therefore.

Another advantage of all-solid state secondary batteries is the suitability for increasing energy density by means of the stacking of electrodes. Specifically, it is possible to produce batteries having a structure in which electrodes and electrolytes are directly arranged in series. At this time, metal packages sealing battery cells and copper wires or bus-bars connecting battery cells may not be provided, and thus the energy density of batteries can be significantly increased. In addition, favorable compatibility with positive electrode materials capable of increasing potentials and the like can also be considered as advantages.

Due to the respective advantages described above, all-solid state secondary batteries are being developed as next-generation lithium ion batteries (New Energy and Industrial Technology Development Organization (NEDO), Fuel Cell and Hydrogen Technologies Development Department, Electricity Storage Technology Development Section. “NEDO 2013 Roadmap for the Development of Next Generation Automotive Battery Technology” (August, 2013)). For example, JP2014-241240A describes a method for manufacturing a sulfide all-solid state battery including a step of forming a coated film of a paste-form composition produced using a sulfide solid electrolyte, a substance developing a viscosity-increasing effect, and a solvent. Here, the substance developing a viscosity-increasing effect has a main chain which is a divalent organic group and functional groups selected from the group consisting of a benzoyloxy group at both ends of this main chain.

### SUMMARY OF THE INVENTION

In the paste-form composition described in JP2014-241240A, the substance which has a poor reactivity with the sulfide solid electrolyte and develops a viscosity-increasing effect is used in order to form an intended form of coated films. However, in sulfide all-solid state batteries produced using this paste-form composition, favorable interfaces are not formed among solid particles, and in the method for manufacturing a sulfide all-solid state battery described in JP2014-241240A, battery performance-improving effects such as suppression of the resistance of all-solid state secondary batteries or improvement of cycle characteristics are not considered to be sufficient.

Therefore, an object of the present invention is to provide a solid electrolyte composition, a mixture, and complexed gel which suppress resistance and are capable of realizing favorable cycle characteristics in all-solid state secondary batteries, an electrode sheet for an all-solid state secondary battery, and an all-solid state secondary battery for which the solid electrolyte composition, the mixture, and the complexed gel are used, and methods for manufacturing a solid electrolyte composition, complexed gel, an electrode sheet for an all-solid state secondary battery, and an all-solid state secondary battery.

As a result of intensive studies, the present inventors and the like found that, in a case in which a solid electrolyte composition containing a low-molecular-weight gellant, which is capable of forming self-assembled nanofibers and thus gelatinizing dispersion media, is used, resistance is suppressed, and all-solid state secondary batteries having favorable cycle characteristics can be realized. This is considered to be attributed to the following reasons including assumptions. That is, due to the presence of the self-assembled nanofibers that are formed from the low-molecular-weight gellant, the distances between solid particles of inorganic solid electrolytes, active materials, and the like in all-solid state secondary batteries are maintained in a certain range. In addition, the self-assembled nanofibers are formed by physical bonding and are thus significantly flexible and easily follow the expansion and contraction of active materials. Furthermore, the self-assembled nanofibers have a nanofiber shape and are thus considered not to hinder lithium ion conduction. The present invention is based on the above-described finding.

That is, the object is achieved by the following means.

(1) A solid electrolyte composition comprising: a low-molecular-weight gellant; an inorganic solid electrolyte having conductivity of ions of metals belonging to Group I or II of the periodic table; and a dispersion medium.

(2) The solid electrolyte composition according to (1), in which the low-molecular-weight gellant includes a compound which has a molecular weight of 300 or more and less than 1,000 and has an alkyl group having 8 or more carbon atoms and a partial structure represented by Formula (I).

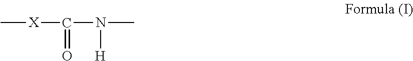

In Formula (I), X represents any one of a single bond, an oxygen atom, and NH.

(3) The solid electrolyte composition according to (2), in which the low-molecular-weight gellant includes a compound which has two or more partial structures represented by Formula (I) and has one or more alkyl groups having 8 or more carbon atoms.

(4) The solid electrolyte composition according to any one of (1) to (3), in which the low-molecular-weight gellant includes a compound which has an alkyl group having 8 or more carbon atoms in a molecular terminal.

(5) The solid electrolyte composition according to any one of (1) to (4), in which a melting point of the low-molecular-weight gellant is 80° C. or higher.

(6) The solid electrolyte composition according to any one of (1) to (5), in which the low-molecular-weight gellant includes an optically active compound.

(7) The solid electrolyte composition according to (2) or (3), in which the partial structure represented by Formula (I) is represented by any one of Formulae (I-1) and (I-2).

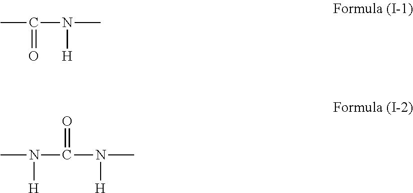

(8) The solid electrolyte composition according to any one of (1) to (7), in which the low-molecular-weight gellant includes at least one compound represented by any one of Formulae (1) to (4).

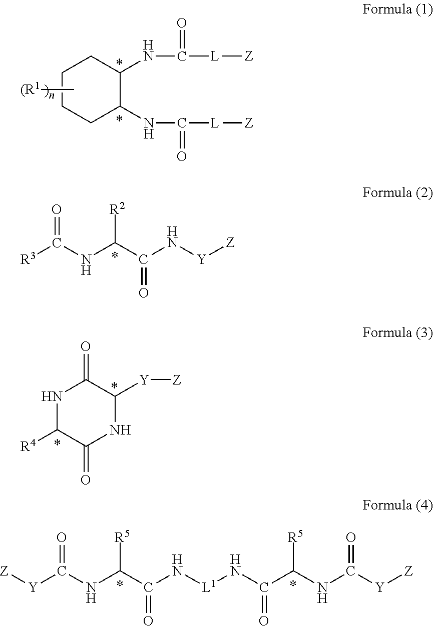

In Formulae (1) to (4), R¹ represents a monovalent organic group, n represents an integer of 0 to 8, R² represents a monovalent organic group, R³ represents a monovalent organic group or —Y—Z, R⁴ represents a monovalent organic group, and R⁵ represents a monovalent organic group. L represents any group of a single bond, an oxygen atom, and NH. Y represents a single bond or a divalent linking group, and Z represents an alkyl group having 8 or more carbon atoms, and L¹ represents a divalent linking group. * represents an optically active carbon atom.

(9) The solid electrolyte composition according to (8), in which, in Formulae (1) to (4), the alkyl group having 8 or more carbon atoms represented by Z has a polymerizable or cationic-polymerizable functional group.

(10) The solid electrolyte composition according to any one of (1) to (9), in which the inorganic solid electrolyte having conductivity of ions of metals belonging to Group I or II of the periodic table is a sulfide-based inorganic solid electrolyte.

(11) The solid electrolyte composition according to any one of (1) to (10), in which part or all of the inorganic solid electrolyte having conductivity of ions of metals belonging to Group I or II of the periodic table is dissolved.

(12) The solid electrolyte composition according to any one of (1) to (11), in which 0.1 to 20 parts by mass of the low-molecular-weight gellant is contained with respect to 100 parts by mass of the inorganic solid electrolyte.

(13) The solid electrolyte composition according to any one to (1) to (12), in which the dispersion medium is a hydrocarbon-based solvent.

(14) The solid electrolyte composition according to any one of (1) to (13), further comprising a binder.

(15) The solid electrolyte composition according to (14), in which the binder is polymer particles having an average particle diameter of 0.05 μm to 20 μm.

(16) A mixture for the solid electrolyte composition according to any one of (1) to (15), the mixture comprising: an inorganic solid electrolyte having conductivity of ions of metals belonging to Group I or II of the periodic table; a dispersion medium; and gel, in which the gel includes at least a low-molecular-weight gellant and a solvent.

Here, the gel may include a second inorganic solid electrolyte having conductivity of ions of metals belonging to Group I or II of the periodic table and/or an electrode active material, and the second inorganic solid electrolyte may be dispersed or dissolved in the gel.

(17) A method for manufacturing a solid electrolyte composition, comprising: mixing the mixture for a solid electrolyte composition according to (16).

(18) A method for manufacturing a solid electrolyte composition, the method comprising Steps (i) to (iii):

Step (i): a step of heating a pre-liquid mixture a containing a low-molecular-weight gellant and a solvent and preparing a liquid mixture a in which the low-molecular-weight gellant is dissolved;

Step (ii): a step of cooling the liquid mixture a and forming gel; and

Step (iii): a step of mixing the gel, a first inorganic solid electrolyte having conductivity of ions of metals belonging to Group I or II of the periodic table, and a dispersion medium and preparing a solid electrolyte composition.

Here, a step of adding a second inorganic solid electrolyte having conductivity of ions of metals belonging to Group I or II of the periodic table and/or an electrode active material to the pre-liquid mixture a, the liquid mixture a, or the gel may be included, and the second inorganic solid electrolyte may be dispersed or dissolved in the gel.

(19) A method for manufacturing an electrode sheet for an all-solid state secondary battery, the method comprising: applying the solid electrolyte composition according to any one of (1) to (15) or a solid electrolyte composition obtained using the manufacturing method according to (17) or (18) onto a metal foil; gelatinizing the solid electrolyte composition; and forming a film.

(20) An electrode sheet for an all-solid state secondary battery comprising in order: a positive electrode active material layer; a solid electrolyte layer; and a negative electrode active material layer, in which at least one of the positive electrode active material layer, the solid electrolyte layer, and the negative electrode active material layer contains a low-molecular-weight gellant and an inorganic solid electrolyte having conductivity of ions of metals belonging to Group I or II of the periodic table.

(21) An all-solid state secondary battery constituted using the electrode sheet for an all-solid state secondary battery according to (20).

(22) A method for manufacturing an all-solid state secondary battery, in which an all-solid state secondary battery having a positive electrode active material layer, a solid electrolyte layer, and a negative electrode active material layer in this order is manufactured through the manufacturing method according to (19).

(23) Complexed gel comprising: a low-molecular-weight gellant; a solvent; and an inorganic solid electrolyte having conductivity of ions of metals belonging to Group I or II of the periodic table. Here, the inorganic solid electrolyte may be dispersed or dissolved in the complexed gel.

(24) A method for manufacturing the complexed gel according to (23), the method comprising Steps (i-A) and (ii-Ai) in this order and Step (A):

Step (i-A): a step of heating a pre-liquid mixture Aa containing the low-molecular-weight gellant and the solvent and preparing a liquid mixture Aa in which the low-molecular-weight gellant is dissolved;

Step (ii-A): a step of cooling the liquid mixture Aa and forming gel; and

Step (A): a step of adding an inorganic solid electrolyte having conductivity of ions of metals belonging to Group I or II of the periodic table to the pre-liquid mixture Aa, the liquid mixture Aa, or the gel.

Here, the complexed gel may include an electrode active material, and the inorganic solid electrolyte may be dispersed or dissolved in the complexed gel.

In the present specification, numerical ranges expressed using “to” include numerical values before and after the “to” as the lower limit value and the upper limit value.

In the present specification, when a plurality of substituents represented by specific symbols is present or a plurality of substituents or the like is simultaneously or selectively determined (similarly, when the number of substituents is determined), the respective substituents and the: like may be identical to or different from each other.

In the present specification, “acryl” that is simply expressed is used to refer o both methacryl and acryl.

In the present specification, “electrode active materials” that are simply expressed are used to refer to both positive electrode active materials and negative electrode active materials.

The solid electrolyte composition, mixture, and complexed gel of the present invention can be preferably used to manufacture all-solid state secondary batteries having favorable cycle characteristics since resistance is suppressed. In addition, the electrode sheet for an all-solid state secondary battery of the present invention enables the manufacturing of all-solid state secondary batteries having excellent performance described above. In addition, according to the manufacturing methods of the present invention, it is possible to efficiently manufacture the electrode sheet for an all-solid state secondary battery of the present invention and all-solid state secondary batteries having excellent performance described above. Furthermore, according to the methods for a solid electrolyte composition and complexed gel of the present invention, it is possible to manufacture state secondary batteries having the above-described performance that is superior.

The above-described and other characteristics and advantages of the present invention will be further clarified by the following description with appropriate reference to the accompanying drawings.

### BRIEF DESCRIPTION OF THE DRAWINGS

FIG. 1 is a vertical cross-sectional view schematically illustrating an all-solid state lithium ion secondary battery according to a preferred embodiment of the present invention.

FIG. 2 is a vertical cross-sectional view schematically illustrating a testing device used in examples.

### DESCRIPTION OF THE PREFERRED EMBODIMENTS

A solid electrolyte composition of the present invention contains a low-molecular-weight gellant, an inorganic solid electrolyte having conductivity of ions of metals belonging to Group I or II of the periodic table, and a dispersion medium.

It is assumed that the battery performance of all-solid state secondary batteries for which the solid electrolyte composition of the present invention is used is improved through the following mechanism.

In a case in which heat energy is added to the solid electrolyte composition of the present invention through mechanical dispersion, the low-molecular-weight gellant dissolves. In a dispersion slurry in which components have been completely dispersed but which is to be applied, gelatinization does not proceed and the viscosity does not change for a short period of time. From this viewpoint, the low-molecular-weight gellant in the present invention is not the pliant described in JP2014-241240A and is a compound having functions that are different from those of substances developing a viscosity-increasing effect.

In a case in which the dispersion slurry is left to stand for a certain period of time in a stage of being applied, the dispersion slurry gelatinizes in a state of including the dispersion medium. Regarding the mechanism of causing the gelatinization, as described in “The Latest Trend of Macromolecular Gel” (published by CMC Publishing Co., Ltd. on 2004), the dispersion slurry is crosslinked by weak secondary bonds such as hydrogen bonds, Van der Waals interaction, hydrophobic interaction, electrostatic interaction, and π-π interaction, and network-shaped self-assembled nanofibers are formed. In a case in which the gelatinized coated substance is dried at a temperature that is equal to or lower than the melting point of the low-molecular-weight gellant, the dispersion medium volatilizes, and only the self-assembled nanofibers remain in the coated film. Therefore, it is considered that a structure in which the inorganic solid electrolyte is incorporated into the network-shaped self-assembled nanofibers is formed, and the performance of all-solid state secondary batteries is improved. Particularly, it is considered that the self-assembled nanofibers are crosslinked with each other by the weak secondary bond and are thus flexible enough to easily follow the expansion and contraction of active materials and the self-assembled nanofibers have a network shape and thus do not easily hinder lithium ion conduction.

Hereinafter, a preferred embodiment will be described.

<Preferred Embodiment>

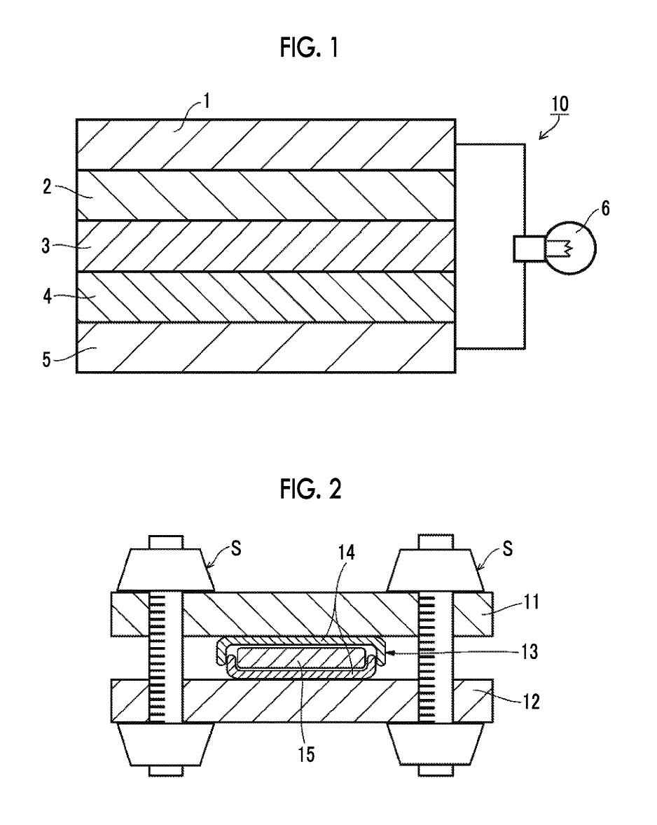

FIG. 1 is a cross-sectional view schematically illustrating an all-solid state secondary battery (lithium ion secondary battery) according to a preferred embodiment of the present invention. In the case of being seen from the negative electrode side, an all-solid state secondary battery 10 of the present embodiment has a negative electrode collector 1, a negative electrode active material layer 2, a solid electrolyte layer 3, a positive electrode active material layer 4, and a positive electrode collector 5 in this order. The respective layers are in contact with one another and have a laminated structure. In a case in which the above-described structure is employed, during charging, electrons (e⁻) are supplied to the negative electrode side, and lithium ions (Li⁺) are accumulated on the negative electrode side. On the other hand, during discharging, the lithium ions (Li⁺) accumulated on the negative electrode side return to the positive electrode, and electrons are supplied to an operation portion 6. In an example illustrated in the drawing, an electric bulb is employed as the operation portion 6 and is lit by discharging. The solid electrolyte composition of the present invention can be preferably used as a material used to form the negative electrode active material layer, the positive electrode active material layer, and the solid electrolyte layer.

The thicknesses of the positive electrode active material layer 4, the solid electrolyte layer 3, and the negative electrode active material layer 2 are not particularly limited. Meanwhile, in a case in which the dimensions of ordinary batteries are taken into account, the thicknesses are preferably 10 to 1,000 μm and more preferably 20 μm or more and less than 500 μm.

Hereinafter, the solid electrolyte composition of the present invention which can be preferably used to manufacture an all-solid state secondary battery of the present invention will be described.

<Solid Electrolyte Composition>

(Low-Molecular-Weight Gellant)

As described in, for example, pp 21 to 26 of “Polymer Processing” Vol. 45, Issue 1, (1996) or pp. 27 to 44 of “The Latest Trend of Macromolecular Gel (published by CMC Publishing Co., Ltd.) (2004), the low-molecular-weight gellant is a medicine capable of solidifying organic solvents or other oils entirely in a jelly form in the case of being added in a small amount thereto, and a variety of gellants are known.

The low-molecular-weight gellant that is used in the present invention refers to a low-molecular-weight material capable of forming a self-assembled nanofiber in a dispersion medium. That is, the low-molecular-weight gellant is a low-molecular-weight (molecular weight of 10 or more and less than 1,000) material having a function with which the low-molecular-weight gellant is capable of solidifying (gelatinizing) dispersion media in a jelly form in the case of being added in a small amount to the dispersion media, heated, and cooled in the air. The gelatinization of dispersion media is assumed to be caused by the fact that the low-molecular-weight gellant forms a one-dimensional molecular assembly in the dispersion medium through weak secondary bonds such as hydrogen bonds, Van der Waals interaction, hydrophobic interaction, electrostatic interaction, and π-π interaction, the molecular assembly grows and thus forms a pseudo-macromolecular body (self-assembled nanofibers), and furthermore, the self-assembled nanofibers twist together in three dimensions.

Therefore, unlike high-molecular-weight gellant having crosslinking points through chemical bonds (for example, polymers such as sodium polyacrylate), due to the association through physical bonds, the self-assembled nanofibers have excellent flexibility and are capable of appropriately setting the flexibility of gel. In addition, the low-molecular-weight gellant is also different from so-called viscosity improvers which have a function of increasing viscosity but do not have a gelatinization capability through the formation of self-assembled nanofibers (for example, n-octanediamine and 1,4-dibenzoylbutane described in JP2014-241240A).

In the present invention, the self-assembly refers to a phenomenon in which molecules voluntarily gather together, and the nanofiber refers to an ultrafine fiber having a long diameter of 0.1 to 100 nm and a short diameter of 0.1 to 50 nm as the diameter, and the length is preferably 0.5 μm or more.

The nanofibers can be confirmed using a transmission electron microscope or scanning electron microscope.

In the present invention, as described above, substances known as oil gellant can be used as the low-molecular-weight gellant with no particular limitations. Specific examples of preferred low-molecular-weight gellants include 12-hydroxystearic acid, N-lauroyl-L-glutamic acid-α, γ-bis-n-butylamide, 1,2,3,4-dibenzylidene-D-sorbitol, aluminum dialkyl phosphate, 2,3-bis-n-hexadecyloxyanthracene, trialkyl-cis-1,3,5-cyclohexane tricarboxamide, ester derivatives of cholesterol, and cyclohexanediamine derivatives.

The low-molecular-weight gellant that is used in the present invention preferably include a compound which has a molecular weight of 300 or more and less than 1,000 and has an alkyl group having 8 or more carbon atoms and a partial structure represented by Formula (I) and is more preferably a compound which has a molecular weight of 300 or more and less than 1,000 and has an alkyl group having 8 or more carbon atoms and a partial structure represented by Formula (I).

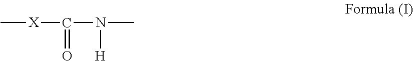

In Formula (I), X represents any one of a single bond, an oxygen atom, and NH.

The low-molecular-weight gellant that is used in the present invention preferably has, among partial structures represented by Formula (I), a partial structure represented by any one of Formulae (I-1) and (I-2) and more preferably has a partial structure represented by Formula (I-1).

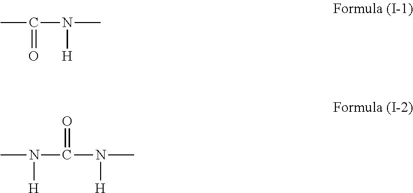

The molecular weight is preferably 300 or more and less than 800 and more preferably 350 or more and less than 650. Here, the molecular weight is obtained by determining the structure using, for example, a variety of spectrometry such as NMR.

The alkyl group having 8 or more carbon atoms may be a linear alkyl group or a branched alkyl group.

The number of carbon atoms is preferably 8 to 20, more preferably 8 to 16, and still more preferably 8 to 12.

In a case in which the alkyl group is a branched alkyl group, the longest alkyl group preferably has 8 or more carbon atoms, more preferably has 8 to 18 carbon atoms, still more preferably has 8 to 14 carbon atoms, and particularly preferably has 8 to 10 carbon atoms.

Specific examples thereof include octyl, nonyl, decyl, dimethyloctyl, undecyl, dodecyl, trimethylnonyl, tetradecyl, octadecyl, and the like.

In a case in which having the partial structure represented by Formula (I), particularly, the partial structure represented by Formulae (I-1) and (I-2), the low-molecular-weight gellant easily forms molecular associates through intermolecular hydrogen bonds. Therefore, the self-assembled nanofibers that are formed in a case in which all-solid state secondary batteries are produced using the solid electrolyte composition of the present invention (hereinafter, referred to as the self-assembled nanofibers) easily maintain the structure in which solid particles that are inorganic solid electrolytes or active materials twist together in a network shape even after the removal of the dispersion medium. Therefore, the self-assembled nanofibers can be preferably used in the present invention.

Furthermore, low-molecular-weight gellants having a molecular weight in the preferred range described above and having an alkyl group having carbon atoms in the preferred range described above are also preferred from the same viewpoint as described above.

The low-molecular-weight gellant that is used in the present invention is also preferably a compound having two or more partial structures represented by Formula (I) and having one or more alkyl groups having 8 or more carbon atoms since it is possible to increase the gelatinization efficiency.

In addition, the low-molecular-weight gellant that is used in the present invention also preferably has an alkyl group having 8 or more carbon atoms in the molecular terminal since the solubility in hydrocarbon solvents is imparted and it is possible to further increase the gelatinization efficiency.

In the present invention, “the low-molecular-weight gellant has an alkyl group having 8 or more carbon atoms in the molecular terminal” means that the low-molecular-weight gellant has an alkyl group having 8 or more carbon atoms in an arbitrary terminal. Meanwhile, in a case in which the alkyl group having 8 or more carbon atoms (Z) has a radical-polymerizable or cationic-polymerizable functional group as in preferred aspects of Formulae (1) to (4) described below, for convenience, the low-molecular-weight gellant is considered to have Z in the molecular terminal.

The low-molecular-weight gellant that is used in the present invention has a melting point being preferably 80° C. or higher, more preferably 100° C. or higher, and still more preferably 120° C. or higher. The upper limit value is preferably 300° C. or lower and more preferably 200° C. or lower.

In a case in which the melting point is equal to or higher than the lower limit value, the structure of the self-assembled nanofibers that are formed by the low-molecular-weight gellant is maintained in a step of removing the dispersion medium during the manufacturing of all-solid state secondary batteries. Therefore, it is possible to maintain a state in which solid particles of solid electrolytes, active materials, and the like twist together in the network-shaped self-assembled nanofibers. In addition, the structure of the self-assembled nanofibers is maintained even during the driving of batteries, which is preferable. In addition, in a case in which the melting point is equal to or lower than the upper limit value, it is possible to prepare a state in which the low-molecular-weight gellant is melted with low energy.

Meanwhile, the melting point of the low-molecular-weight gellant is preferably higher than the drying temperature described in the section of the production of an all-solid state secondary battery described below, more preferably the drying temperature+30° C. or more, and still more preferably the drying temperature+50° C. or more.

The melting point can be measured by means of differential scanning calorimetry (DSC).

The low-molecular-weight gellant that is used in the present invention is also preferably optically active. This is because, in a case in which the molten low-molecular-weight gellant is self-assembled, the low-molecular-weight gellant having regularity is arrayed, which facilitates the formation of nano-fibers, and, in all-solid state secondary batteries, it is easy to maintain stable nanofiber structures even after the removal of the dispersion medium.

The low-molecular-weight gellant that is used in the present invention is preferably represented by any one of Formulae (1) to (4). Here, the low-molecular-weight gellants represented by Formulae (1) to (4) are all optically active.

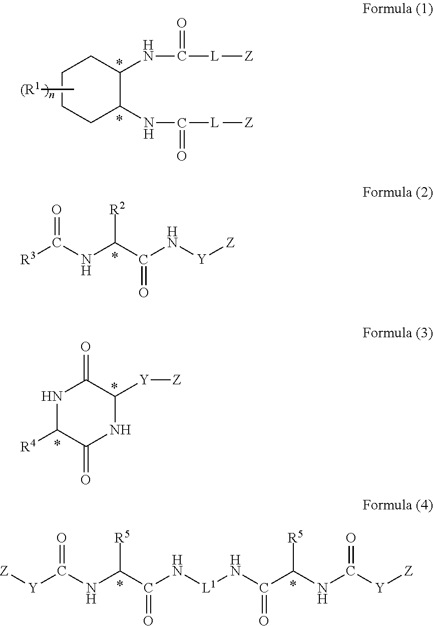

In Formulae (1) to (4), R¹ represents a monovalent organic group, n represents an integer of 0 to 8, R² represents a monovalent organic group, R³ represents a monovalent organic group or —Y—Z, R⁴ represents a monovalent organic group, and R⁵ represents a monovalent organic group. L represents any group of a single bond, an oxygen atom, and NH. Y represents a single bond or a divalent linking group, and Z represents an alkyl group having 8 or more carbon atoms, and L¹ represents a divalent linking group. * represents an optically active carbon atom. Meanwhile, * may be R or S.

Examples of the monovalent organic group in R¹ to R⁵ include an alkyl group, an aryl group, an alkoxy group, an aryloxy group, an alkylthio group, and an arylthio group.

The number of carbon atoms in the alkyl group is preferably 1 to 30, more preferably 1 to 25, and still more preferably 1 to 20. Specific examples thereof include methyl, ethyl, propyl, isopropyl, butyl, t-butyl, octyl, dodecyl, stearyl, benzyl, and the like.

The number of carbon atoms in the aryl group is preferably 6 to 30, more preferably 6 to 20, and still more preferably 6 to 14. Specific examples thereof include phenyl, 1-naphthyl, tolyl, xylyl, anthracenyl, pyrenyl, and the like.

The number of carbon atoms in the alkoxy group is preferably 1 to 20, more preferably 1 to 12, and still more preferably 1 to 8. Specific examples thereof include methoxy, ethoxy, isopropyloxy, benzyloxy, and the like.

The number of carbon atoms in the aryloxy group is preferably 6 to 20, more preferably 6 to 12, and still more preferably 6 to 10. Specific examples thereof include phenoxy, 1-naphthyloxy, 3-methylphenoxy, 4-methoxyphenoxy, and the like.

The number of carbon atoms in the alkylthio group is preferably 1 to 20, more preferably 1 to 12, and still more preferably 1 to 8. Specific examples thereof include methylthio, ethylthio, isopropylthio, benzylthio, and the like.

The number of carbon atoms in the arylthio group is preferably 6 to 30, more preferably 6 to 20, and still more preferably 6 to 14. Specific examples thereof include phenylthio, 1-naphthylthio, 3-methylphenylthio, 4-methoxyphenylthio, and the like.

The monovalent organic group as R¹ is preferably an alkyl group or an alkoxy group.

The monovalent organic group as R² is preferably an alkyl group.

The monovalent organic group as R³ is preferably an alkoxy group, an aryloxy group, an alkylthio group, or an arylthio group.

The monovalent organic group as R⁴ is preferably an alkyl group.

The monovalent organic group as R⁵ is preferably an alkyl group.

R³ is preferably an alkoxy group or —Y—Z.

n is preferably an integer of 0 to 4, more preferably an integer of 0 or 2, and still more preferably 0.

L is preferably a single bond or NH.

Examples of the divalent linking group as Y include —O—, —S—, —NH—, —C(═O)—, —Lr—, and combinations thereof.

Here, Lr represents an alkylene group, may be linear or branched, and preferably has 1 to 12 carbon atoms and more preferably has 1 to 6 carbon atoms.

Examples of the combination of the divalent linking groups include —NHC(═O—, —NHC(═O)O—, —NHC(═O)NH—, —Lr—O—, —Lr—NH—, —Lr—C(═O)—, —Lr—C(═O)O—, —Lr—O—C(═O)—, —Lr—C(═O)NH—, and —Lr—NHC(═O)—.

Among these, the divalent linking group as Y is preferably —O—, —NH—, —Lr—C(═O)O—, or —Lr—C(═O)NH—, more preferably —O—, —NH—, —CH₂C(═O)O—, or —CH(CH(CH₃)₂)—C(═O)NH—.

The divalent linking group as L¹ is preferably an alkylene group.

The number of carbon atoms in the alkylene group is preferably 1 to 30, more preferably 1 to 25, and still more preferably 1 to 20. Specific examples thereof include methylene, ethylene, propylene, butylene, octamethylene, dodecamethylene, octadecamethylene, and the like.

The alkyl group having 8 or more carbon atoms in Z is the same as the alkyl group having 8 or more carbon atoms.

Z also preferably has a radical-polymerizable or cationic-polymerizable functional group.

Examples of the radical-polymerizable functional group include groups having a carbon-carbon unsaturated group such as a (meth)acryloyl group, a vinyloxy group, a styryl group, and an allyl group, and, among these, a (meth)acryloyl group is preferred.

Examples of the cationic-polymerizable functional group include an epoxy group, a thioepoxy group, a vinyloxy group, an oxetanyl group, and the like, and, among these, an oxetanyl group is preferred.

Meanwhile, Z and the radical-polymerizable or cationic-polymerizable functional group may be bonded to each other through a divalent linking group, and specific examples of the divalent linking group include an alkyleneoxy group (preferably having 1 to 10 carbon atoms, for example, —CH₂O—), a carbonyloxy group (—C(═O)O—), and a carbonate group (—OC(═O)O—).

The radical-polymerizable or cationic-polymerizable functional groups are preferably polymerized together since chemical bonds are formed among some of the molecules of the low-molecular-weight gellant that forms the self-assembled nanofibers, and thus the physical shape as well as the physical bonds of the self-assembled nanofibers are maintained. In addition, chemical crosslinking is preferably formed since the structure of the self-assembled nanofibers can also be maintained at a high temperature that is equal to or higher than the melting point of the low-molecular-weight gellant.

As described below in the section of the manufacturing of an all-solid secondary battery, in a case in which the solid electrolyte composition in which the low-molecular-weight gellant is dissolved is subjected to a step of forming a film and a step of cooling the film in the air, the self-assembled nanofibers are formed. Therefore, in order to obtain an effect of the self-assembled nanofibers and a synergetic effect of the formation of chemical bonds (crosslinking), it is effective to carry out radical polymerization or cationic polymerization after the formation of the self-assembled nanofibers. That is, polymerization is preferably carried out after cooling in the air or drying.

In a case in which Z has the radical-polymerizable or cationic-polymerizable functional group, the solid electrolyte composition of the present invention is capable of appropriately containing a radical initiator and a cationic polymerization initiator.

In order to initiate polymerization, the radical-polymerizable or cationic-polymerizable functional group may be exposed to a variety of active light rays (ultraviolet rays, electron beams, plasma, X-rays, excimer lasers, and the like), or electrolytic polymerization may be carried out by the charging and discharging of all-solid state secondary batteries.

The low-molecular-weight gellant that is used in the present invention preferably has two or more radical-polymerizable or cationic-polymerizable functional groups in the molecule.

Among the low-molecular-weight gellants represented by Formulae (1) to (4), the low-molecular-weight gellant represented by Formula (2) or (4) is more preferred.

Hereinafter, specific examples of the low-molecular-weight gellant that is used in the present invention will be illustrated, but the present invention is not limited to these low-molecular-weight gellants. Meanwhile, in the chemical structure formulae below, (A-3) to (A-18) are optically active.

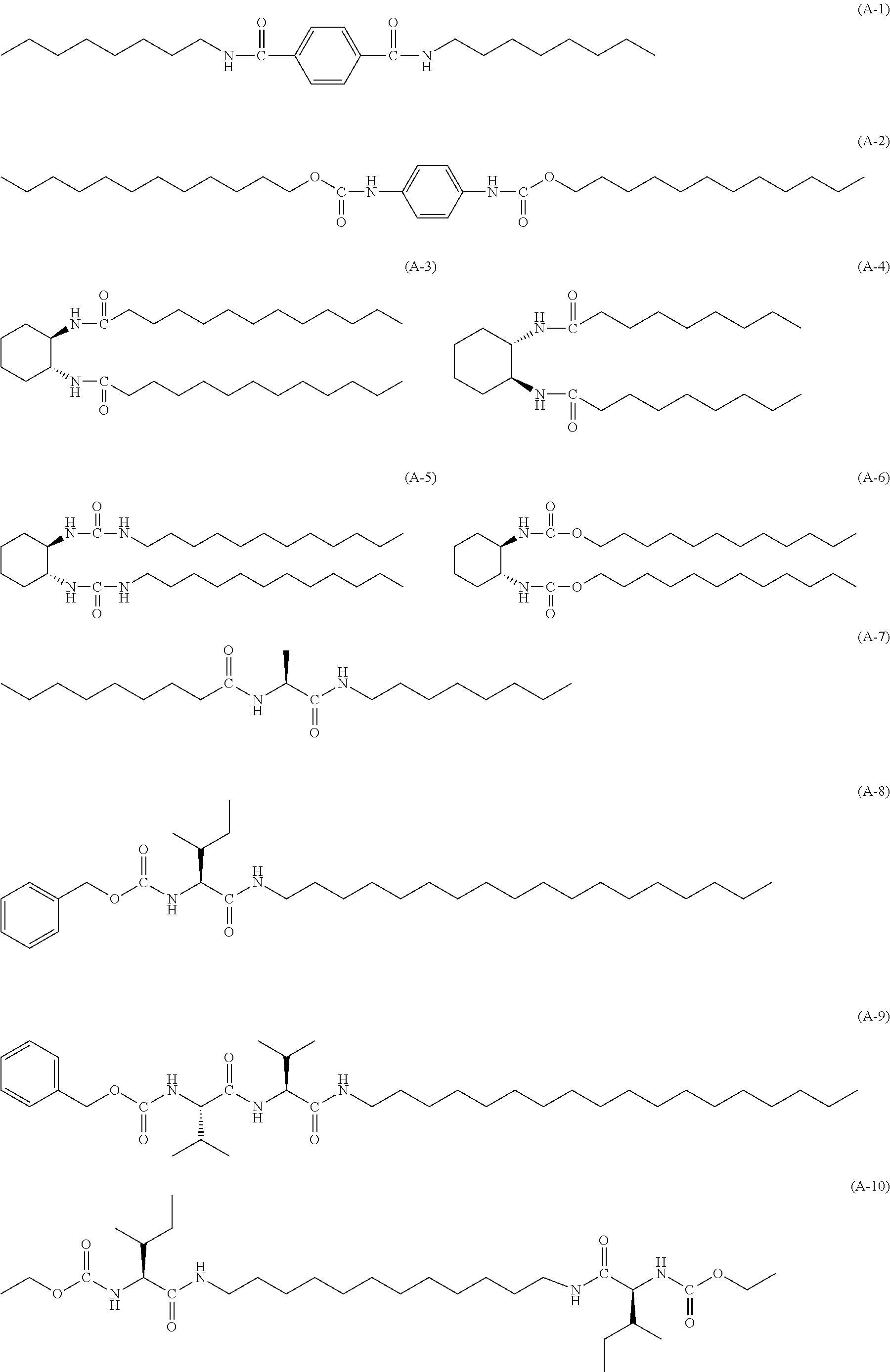

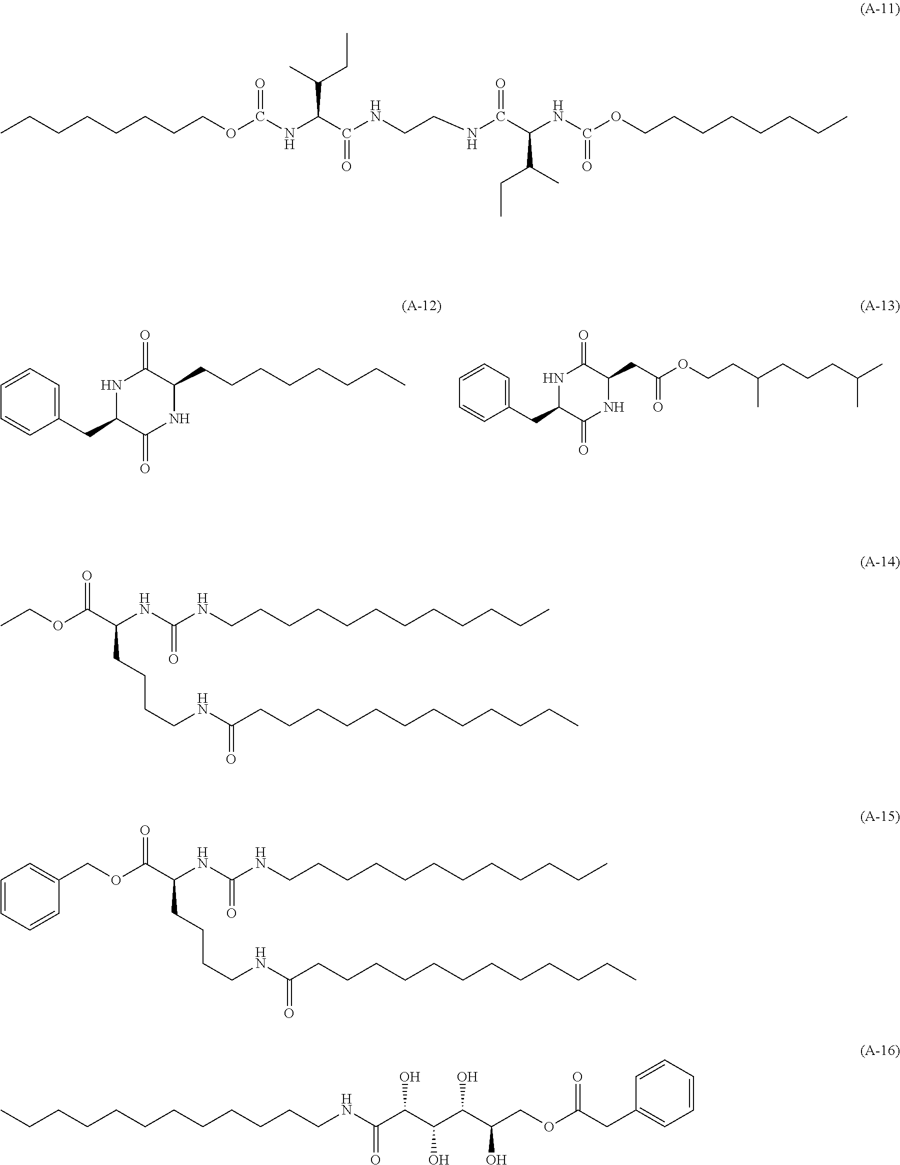

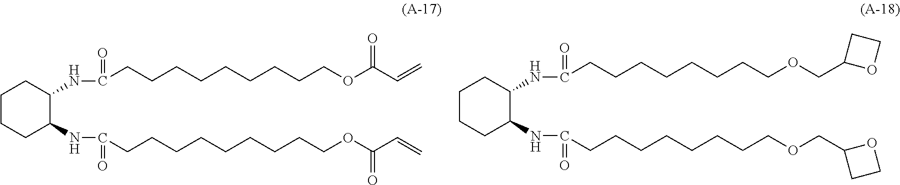 [SMILES: C=CC(=O)OCCCCCCCCCC(=O)N[C@H]1CCCC[C@@H]1NC(=O)CCCCCCCCCOC(=O)C=C ; O=C(CCCCCCCCOCC1CCO1)N[C@H]1CCCC[C@@H]1NC(=O)CCCCCCCCOCC1CCO1]

Meanwhile, the low-molecular-weight gellant can be synthesized using an ordinary method.

For example, methods for synthesizing (1) an amino acid-based oil gellant, (2) a cyclic dipeptide-based oil gellant, and (3) a cyclohexanediamine-based oil gellant which are representative low-molecular-weight gellants will be described below.

(1) Amino Acid-Based Oil Gellant (Exemplary Compounds A-7 to 11)

An amino acid is used as a starting material. Among amino acids, low-molecular-weight gellants synthesized using L-isoleucine or L-valine as a starting material are known to have a favorable gelatinization capability. First, an amino group in an amino acid is turned into an amide or urethane using an acid chloride, then, a carboxylic acid portion in the amino acid and an amine are reacted together using a condensation agent (DCC: dicyclohexylcarbodiimide or the like) so as to produce an amide, thereby obtaining the gellant.

(2) Cyclic Dipeptide-Based Oil Gellant (Exemplary Compounds A-12 and 13)

A dipeptide methyl ester consisting of asparagine acid and another different amino acid is used as a starting material. First, the asparagine acid-containing dipeptide methyl ester is heated so as to cause the cyclization condensation of an amino group in the asparagine acid and methyl ester in the molecule, thereby forming diketopiperazines. The remaining carboxylic acid and alcohol are heated, dehydrated, and condensed using a condensation agent (DCC: dicyclohexylcarbodiimide or the like) so as to produce an ester, thereby obtaining the gellant. Among them, low-molecular-weight gellants synthesized using a peptide methyl ester (aspartame) consisting of asparagine acid and phenylalanine as a starting material are known to have a favorable gelatinization capability.

(3) Cyclohexanediamine-Based Oil Gellant (Exemplary Compounds A-3 to 6, 17, and 18)

Two amino groups in optically active trans-1,2-cyclohexanediamine are turned into an amide using an acid chloride or turned into an urea using isocyanate, thereby obtaining the gellant. Meanwhile, in order to provide a gelatinization capability, the two amino groups need to be trans bodies, and the compound obtained by a reaction needs to be an optically active body.

In the present specification, substituents which are not clearly expressed as substituted or unsubstituted (which is also true for linking groups) may have an arbitrary substituent in the groups. This is also true for compounds which are not clearly expressed as substituted or unsubstituted. Examples of preferred substituents include the following substituent T.

Examples of the substituent T include the following substituents.

Alkyl groups (preferably alkyl groups having 1 to 20 carbon atoms, for example, methyl, ethyl, isopropyl, t-butyl, pentyl, heptyl, 1-ethylpentyl, benzyl, 2-ethoxyethyl, 1-carboxymethyl, and the like), alkenyl groups (preferably alkenyl groups having 2 to 20 carbon atoms, for example, vinyl, allyl, oleyl, and the like), alkynyl groups (preferably alkynyl groups having 2 to 20 carbon atoms, for example, ethynyl, butadiynyl, phenylethynyl, and the like), cycloalkyl groups (preferably cycloalkyl groups having 3 to 20 carbon atoms, for example, cyclopropyl, cyclopentyl, cyclohexyl, 4-methylcyclohexyl, and the like), aryl groups (preferably aryl groups having 6 to 26 carbon atoms, for example, phenyl, 1-naphthyl, 4-methoxyphenyl, 2-chlorophenyl, 3-methylphenyl, and the like), heterocyclic groups (preferably heterocyclic groups having 2 to 20 carbon atoms, preferably heterocyclic groups of a five- or six-membered ring having at least one oxygen atom, sulfur atom, or nitrogen atom, for example, tetrahydropyran, tetrahydrofuran, 2-pyridyl, 4-pyridyl, 2-imidazolyl, 2-benzimidazolyl, 2-thiazolyl, 2-oxazolyl, and the like),

alkoxy groups (preferably alkoxy groups having 1 to 20 carbon atoms, for example, methoxy, ethoxy, isopropyloxy, benzyloxy, and the like), aryloxy groups (preferably aryloxy groups having 6 to 26 carbon atoms, for example, phenoxy, 1-naphthyloxy, 3-methylphenoxy, 4-methoxyphenoxy, and the like), alkoxycarbonyl groups (preferably alkoxycarbonyl groups having 2 to 20 carbon atoms, for example, ethoxycarbonyl, 2-ethylhexyloxycarbonyl, and the like), aryloxycarbonyl groups (preferably aryloxycarbonyl groups having 6 to 26 atoms, for example, phenoxycarbonyl, 1-naphthyoxycarbonyl, 3-methylphenoxycarbonyl, 4-methoxyphenoxycarbonyl, and the like), amino groups (preferably amino groups having 0 to 20 carbon atoms, including an alkylamino group, and an arylamino group, for example, amino, N,N-dimethylamino, N,N-diethylamino, N-ethylamino, anilino, and the like), sulfamoyl groups (preferably sulfamoyl groups having 0 to 20 carbon atoms, for example, N,N-dimethylsulfamoyl, N-phenylsulfamoyl, and the like), acyl groups (preferably acyl groups having 1 to 20 carbon atoms, for example, acetyl, propionyl, butyryl, and the like), aryloyl groups (preferably aryloyl groups having 7 to 23 carbon atoms, for example, benzoyl and the like), acyloxy groups (preferably acyloxy groups having 1 to 20 carbon atoms, for example, acetyloxy and the like), aryloyloxy groups (preferably aryloyloxy groups having 7 to 23 carbon atoms, for example, benzoyloxy group and the like),

carbamoyl groups (preferably carbamoyl groups having 1 to 20 carbon atoms, for example, N,N-dimethylcarbamoyl, N-phenylcarbamoyl, and the like), acylamino groups (preferably acylamino groups having 1 to 20 carbon atoms, for example, acetylamino, benzoylamino, and the like), alkylthio groups (preferably alkylthio groups having 1 to 20 carbon atoms, for example, methylthio, ethylthio, isopropylthio, benzylthio, and the like), arylthio groups (preferably arylthio groups having 6 to 26 carbon atoms, for example, phenylthio, 1-naphthylthio, 3-methylphenylthio, 4-methoxyphenylthio, and the like), alkylsulfonyl groups (preferably alkysulfonyl groups having 1 to 20 carbon atoms, for example, methylsulfonyl, ethylsulfonyl, and the like), arylsulfonyl groups (preferably arylsulfonyl groups having 6 to 22 carbon atoms, for example, benzenesulfonyl and the like), alkylsilyl groups (preferably alkylsilyl groups having 1 to 20 carbon atoms, for example, monomethylsilyl, dimethylsilyl, trimethylsilyl, triethylsilyl, and the like), arylsilyl groups (preferably arylsilyl groups having 6 to 42 carbon atoms, for example, triphenylsilyl, and the like), phosphoryl groups (preferably phosphoric acid groups having 0 to 20 carbon atoms, for example, —OP(—O)(R^{P})₂), phosphonyl groups (preferably phosphonyl groups having 0 to 20 carbon atoms, for example, —P(═O)(R^{P})₂), phosphinyl groups (preferably phosphinyl groups having 0 to 20 carbon atoms, for example, —P(R^{P})₂), a (meth)acryloyl group, a (meth)acryloyloxy group, a hydroxyl group, a cyano group, halogen atoms (for example, a fluorine atom, a chlorine atom, a bromine atom, an iodine atom, and the like).

In addition, in the respective groups exemplified as the substituent T, the substituent T may be further substituted.

R^{N} is a hydrogen atom or a substituent. The substituent is preferably an alkyl group (the number of carbon atoms is preferably 1 to 24, more preferably 1 to 12, still more preferably 1 to 6, and particularly preferably 1 to 3), an alkenyl group (the number of carbon atoms is preferably 2 to 24, more preferably 2 to 12, still more preferably 2 to 6, and particularly preferably 2 and 3), an alkynyl group (the number of carbon atoms is preferably 2 to 24, more preferably 2 to 12, still more preferably 2 to 6, and particularly preferably 2 and 3), an aralkyl group (the number of carbon atoms is preferably 7 to 22, more preferably 7 to 14, and particularly preferably 7 to 10), or an aryl group (the number of carbon atoms is preferably 6 to 22, more preferably 6 to 14, and particularly preferably 6 to 10).

R^{P} is a hydrogen atom, a hydroxyl group, or a substituent. The substituent is preferably an alkyl group (the number of carbon atoms is preferably 1 to 24, more preferably 1 to 12, still more preferably 1 to 6, and particularly preferably 1 to 3), an alkenyl group (the number of carbon atoms is preferably 2 to 24, more preferably 2 to 12, still more preferably 2 to 6, and particularly preferably 2 and 3), an alkynyl group (the number of carbon atoms is preferably 2 to 24, more preferably 2 to 12, still more preferably 2 to 6, and particularly preferably 2 and 3), an aralkyl group (the number of carbon atoms is preferably 7 to 22, more preferably 7 to 14, and particularly preferably 7 to 10), an aryl group (the number of carbon atoms is preferably 6 to 22, more preferably 6 to 14, and particularly preferably 6 to 10), an alkoxy group (the number of carbon atoms is preferably 1 to 24, more preferably 1 to 12, still more preferably 1 to 6, and particularly preferably 1 to 3), an alkenyloxy group (the number of carbon atoms is preferably 2 to 24, more preferably 2 to 12, still more preferably 2 to 6, and particularly preferably 2 and 3), an alkynyloxy group (the number of carbon atoms is preferably 2 to 24, more preferably 2 to 12, still more preferably 2 to 6, and particularly preferably 2 and 3), an aralkyloxy group (the number of carbon atoms is preferably 7 to 22, more preferably 7 to 14, and particularly preferably 7 to 10), or an aryloxy group (the number of carbon atoms is preferably 6 to 22, more preferably 6 to 14, and particularly preferably 6 to 10).

The content of the low-molecular-weight gellant with respect to the dispersion medium in the solid electrolyte composition is preferably 0.1 parts by mass or more, more preferably 0.5 parts by mass or more, and particularly preferably 1 part by mass or more with respect to 100 parts by mass of the dispersion medium. The upper limit is preferably 15 parts by mass or less, more preferably 10 parts by mass or less, and particularly preferably 5 parts by mass or less.

The content is preferably in the preferred range described above since the low-molecular-weight gellant has a sufficient gelatinization capability and does not deteriorate battery performance.

The content of the low-molecular-weight gellant is preferably 0.1 to 20 parts by mass, more preferably 0.5 to 18 parts by mass, and particularly preferably 1 to 15 parts by mass with respect to 100 parts by mass of the inorganic solid electrolyte in the solid electrolyte composition. Here, in a case in which the solid electrolyte composition includes solid components other than the inorganic solid electrolyte and the low-molecular-weight gellant, the total amount of the components including the inorganic solid electrolyte and the above-described solid components is set to 100 parts by mass.

The content is preferably in the preferred range described above since the low-molecular-weight gellant has a sufficient gelatinization capability and does not deteriorate battery performance.

Meanwhile, the solid components in the present specification refer to components that do not disappear through volatilization or evaporation when dried in a vacuum at 100° C. for six hours. Typically, the solid components refer to components other than a dispersion medium described below.

These low-molecular-weight gellants may be used singly or a combination of two or more low-molecular-weight gellants may be used, but it is preferable to use one low-molecular-weight gellant singly.

The low-molecular-weight gellant may be mixed into the solid electrolyte composition in a solid state or it is possible to heat and dissolve the low-molecular-weight gellant in an appropriate solvent so as to form gel and mix the generated physical gel into the solid electrolyte composition.

In addition, the low-molecular-weight gellant may be mixed into the solid electrolyte composition before or after mechanical dispersion that will be described below in the section of the manufacturing of an all-solid state secondary battery; however, in a case in which the low-molecular-weight gellant is mixed into the solid electrolyte composition after the mechanical dispersion, it is preferable to dissolve the low-molecular-weight gellant.

(Inorganic Solid Electrolyte)

The inorganic solid electrolyte is an inorganic solid electrolyte, and the solid electrolyte refers to a solid-form electrolyte capable of migrating ions therein. The inorganic solid electrolyte is clearly differentiated from organic solid electrolytes (macromolecular electrolytes represented by PEO or the like and organic electrolyte salts represented by LiTFSI) since the inorganic solid electrolyte does not include any organic substances as a principal ion-conductive material. In addition, the inorganic solid electrolyte is a solid in a static state and is thus, generally, not disassociated or liberated, into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

In the present invention, the inorganic solid electrolyte has ion conductivity of metals belonging to Group I or II of the periodic table. As the inorganic solid electrolyte, it is possible to appropriately select and use solid electrolyte materials that are applied to this kind of products. Typical examples of the inorganic solid electrolyte include (i) sulfide-based inorganic solid electrolytes and (ii) oxide-based inorganic solid electrolytes.

(i) Sulfide-Based Inorganic Solid Electrolytes

Sulfide-based inorganic solid electrolytes are preferably inorganic solid electrolytes which contain sulfur atoms (S), have ion conductivity of metals belonging to Group I or II of the periodic table, and have electron-insulating properties. The sulfide-based inorganic solid electrolytes are preferably inorganic solid electrolytes which, as elements, contain at least Li, S, and P and have a lithium ion conductivity, but the sulfide-based inorganic solid electrolytes may also include elements other than Li, S, and P depending on the purposes or cases.

Examples thereof include lithium ion-conductive inorganic solid electrolytes satisfying a composition represented by Formula (1).

Lₐ₁M_{b1}P_{c1}S_{d1}Aₑ₁ (1)

(In the formula, L represents an element selected from Li, Na, and K and is preferably Li. M represents an element selected from B, Zn, Sn, Si, Cu, Ga, Sb, Al, and Ge. Among these, B, Sn, Si, Al, and Ge are preferred, and Sn, Al, and Ge are more preferred. A represents I, Br, Cl, and F and is preferably I or Br and particularly preferably I. a1 to e1 represent the compositional ratios among the respective elements, and a1:b1:c1:d1:e1 satisfies 1 to 12:0 to 1:1:2 to 12:0 to 5. Furthermore, a1 is preferably 1 to 9 and more preferably 1.5 to 4. b1 is preferably 0 to 0.5. Furthermore, d1 is preferably 3 to 7 and more preferably 3.25 to 4.5. Furthermore, e1 is preferably 0 to 3 and more preferably 0 to 1.)

In Formula (1), the compositional ratios among L, M, P, S, and A are preferably b1=0 and e1=0, more preferably b1=0, e1=0, and the ratio among a1, c1, and d1 (a1:c1:d1)=1 to 9:1:3 to 7, and still more preferably b1=0, e1=0, and a1:c1:d1=1.5 to 4:1:3.25 to 4.5. The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li—P—S-based glass containing Li, P, and S or Li—P—S-based glass ceramic containing Li, P, and S.

The sulfide-based inorganic solid electrolytes can be manufactured by a reaction of [1] lithium sulfide (Li₂S) and phosphorus sulfide (for example, phosphorus pentasulfide (P₂S₅)), [2] lithium sulfide and at least one of a phosphorus single body and a sulfur single body, or [3] lithium sulfide, phosphorus sulfide (for example, phosphorus pentasulfide (P₂S₅)), and at least one of a phosphorus single body and a sulfur single body.

The ratio between Li₂S and P₂S₅ in Li—P—S-based glass and Li—P—S-based glass ceramic is preferably 65:35 to 85:15 and more preferably 68:32 to 77:23 in terms of the molar ratio between Li₂S:P₂S₅. In a case in which the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

Specific examples of the compound include compounds formed using a raw material composition containing, for example, Li₂S and a sulfide of an element of Groups XIII to XV. Specific examples thereof include Li₂S—P₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, Li₂S—GeS₂—Al₂S₃, Li₂S—SiS₂, Li₂S—Al₂S₃, Li₂S—SiS₂—Al₂S₃, Li₂S—SiS₂—P₂S₅, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Among these, crystalline and/or amorphous raw material compositions consisting of Li₂S—P₂S₅, Li₂S—GeS₂—Ga₂S₃, Li₂S—SiS₂—P₂S₅, Li₂S—SiS₂—Li₄SiO₄, Li₂S—SiS₂—Li₃PO₄, Li₂S—LiI—Li₂O—P₂S₅, Li₂S—Li₂O—P₂S₅, Li₂S—Li₃PO₄—P₂S₅, Li₂S—GeS₂—P₂S₅, and Li₁₀GeP₂S₁₂ are preferred due to their high lithium ion conductivity. Examples of a method for synthesizing sulfide-based inorganic solid electrolyte materials using the above-described raw material compositions include an amorphorization method. Examples of the amorphorization method include a mechanical milling method and a melting quenching method. Among these, the mechanical milling method is preferred. This is because treatments at normal temperature become possible, and it is possible to simplify manufacturing steps.

(ii) Oxide-Based Inorganic Solid Electrolytes

Oxide-based inorganic solid electrolytes are preferably inorganic solid electrolytes which contain oxygen atoms (O), have an ion conductivity of metals belonging to Group I or II of the periodic table, and have electron-insulating properties.

Specific examples of the compounds include LiₓₐLa_{ya}TiO₃ [xa=0.3 to 0.7 and ya=0.3 to 0.7] (LLT), Li_{xb}La_{yb}Zr_{zb}M^{bb}_{mb}O_{nb} (M^{bb} is at least one element of Al, Mg, Ca, Sr, V, Nb, Ta, Ti, Ge, In and Sn, xb satisfies 5≦xb≦10, yb satisfied 1≦yb≦4, zb satisfies 1≦zb≦4, mb satisfies 0≦mb≦2, and nb satisfies 5≦nb≦20.), Li_{xc}B_{yc}M^{cc}_{zc}O_{nc} (M^{cc} is at least one of C, S, Al, Si, Ga, Ge, In, and Sn, xc satisfies 0≦xc≦5, yc satisfies 0≦yc≦1, zc satisfies 0≦zc≦1, and nc satisfies 0≦nc≦6), Li_{xc}(Al, Ga)_{yd}(Ti, Ge)_{zd}Si_{nd}P_{md}O_{nd} (1≦xd≦3, 0≦yd≦1, 0≦zd≦2, 0≦ad≦1, 1≦md≦7, 3≦nd≦13), Li₍₃₋₂ₓₑ₎M^{ee}ₓₑD^{ee}O (xe represents a number of 0 or more and 0.1 or less, and M^{ee} represents a divalent metal atom. D^{ee} represents a halogen atom or a combination of two or more halogen atoms.), Li_{xf}Si_{yf}O_{zf} (1≦xf≦5, 0≦yf≦3, 1≦zf≦10), Li_{xg}S_{yg}O_{zg} (1≦xg≦3, 0<yg≦2, 1≦zg≦10), Li₃BO₃—Li₂SO₄, Li₂O—B₂O₃—P₂O₅, Li₂O—SiO₂, Li₆BaLa₂Ta₂O₁₂, Li₃PO(_{(4-3/2w)}N_{w} (w<1), Li_{3.5}Zn_{0.25}GeO₄ having a lithium super ionic conductor (LISICON)-type crystal structure, La_{0.55}Li_{0.35}TiO₃ having a perovskite-type crystal structure, LiTi₂P₃O₁₂ having a natrium super ionic conductor (NASICON)-type crystal structure. Li_{1+xh+yh}(Al, Ga)ₓₕ(Ti, Ge)₂₋ₓₕSi_{yh}P_{3-yh}O₁₂ (0≦xh≦1, 0≦yh≦1), Li₇La₃Zr₂O₁₂ (LLZ) having a garnet-type crystal structure. In addition, phosphorus compounds containing Li, P and O are also desirable. Examples thereof include lithium phosphate (Li₃PO₄), LiPON in which some of oxygen atoms in lithium phosphate are substituted with nitrogen, LiPOD¹ (D¹ is at least one selected from Ti, V, Cr, Mn, Fe, Co, Ni, Cu, Zr, Nb, Mo, Ru, Ag, Ta, W, Pt, Au, and the like), and the like. It is also possible to preferably use LiA¹ON (A¹ represents at least one selected from Si, B, Ge, Al, C, Ga, and the like) and the like.

In the present invention, the inorganic solid electrolyte having conductivity of ions of metals belonging to Group I or II of the periodic table is preferably the sulfide-based inorganic solid electrolyte since it is possible to obtain batteries having a high ion conductivity and a low resistance.

The volume-average particle diameter of the inorganic solid electrolyte is not particularly limited, but is preferably 0.01 μm or more and more preferably 0.1 μm or more. The upper limit is preferably 100 μm or less and more preferably 50 μm or less. Meanwhile, the volume-average particle diameter of the inorganic solid electrolyte is measured in the following order. One percent by mass of a dispersion liquid is prepared using the inorganic solid electrolyte and water (heptane in a case in which the inorganic solid electrolyte is unstable in water) in a 20 ml sample bottle by means of dilution. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering” is referred to as necessary. Five specimens are produced per level, and the average values thereof are employed.

When a decrease in interface resistance and the maintenance of the decreased interface resistance are taken into account, the concentration of the inorganic solid electrolyte in the solid component of the solid electrolyte composition is preferably 5% by mass or more, more preferably 10% by mass or more, and particularly preferably 20% by mass or more with respect to 100% by mass of the solid components. From the same viewpoint, the upper limit is preferably 99.9% by mass or less, more preferably 99.5% by mass or less, and particularly preferably 99% by mass or less.

These inorganic solid electrolytes may be used singly or two or more inorganic solid electrolytes may be used in combination.

(Binder)

The solid electrolyte composition of the present invention also preferably contains a binder. This is because the binder facilitates the maintenance of nanofibers that are generated from the low-molecular-weight gellant in the present invention, and thus battery voltage and cycle characteristics improve.

The binder that is used in the present invention is not particularly limited as long as the binder is an organic polymer.

The binder that can be used in the present invention is preferably a binder that is generally used as binding agents for positive electrodes or negative electrodes of battery materials, is not particularly limited, and is preferably, for example, a binder consisting of resins described below.

Examples of fluorine-containing resins include polytetrafluoroethylene (PTFE), polyvinylene difluoride (PVdF), copolymers of polyvinylenedifluoride and hexafluoropropylene (PVdF-HFP), and the like.

Examples of hydrocarbon-based thermoplastic resins include polyethylene, polypropylene, styrene butadiene rubber (SBR), hydrogenated styrene butadiene rubber (HSBR), butylene rubber, acrylonitrile, butadiene rubber, polybutadiene, polyisoprene, and the like.

Examples of acrylic resins include poly(methyl (meth)acrylate), poly(ethyl (meth)acrylate), poly(isopropyl (meth)acrylate), poly(isobutyl (meth)acrylate, poly(butyl (meth)acrylate, poly(hexyl (meth)acrylate), poly(octyl (meth)acrylate, poly(dodecyl (meth)acrylate), poly(stearyl (meth)acrylate), poly(2-hydroxyethyl (meth)acrylate), poly(meth)acrylate, poly(benzyl (meth)acrylate), poly(glydicyl (meth)acrylate), poly(dimethylaminopropyl (meth)acrylate), copolymers of monomers constituting the above-described resins, and the like.

In addition, copolymers with other vinyl-based monomers are also preferably used. Examples thereof include poly(methyl (meth)acrylate)-polystyrene copolymers, poly(methyl (meth)acrylate-acrylonitrile copolymers), poly(butyl (meth)acrylate-acrylonitrile-styrene copolymers and the like.

These binders may be used singly or two or more binders may be used in combination.

The binder that can be used in the present invention is preferably polymer particles, and the average particle diameter of the polymer particles is preferably 0.01 μm to 100 μm, more preferably 0.05 μm to 50 μm, and still more preferably 0.05 μm to 20 μm. The average particle diameter is preferably in the preferred range described above from the viewpoint of improvement in output density.

Here, the “polymer particles” refer to particles which are not completely dissolved even in a case in which a dispersion medium described above is added, are dispersed in the dispersion medium in a particle form, and have an average particle diameter of more than 0.01 μm.

The average particle diameter of the polymer particles that are used in the present invention is not particularly limited and refers to an average particle diameter according to the following measurement conditions and definition.

One percent by mass of a dispersion liquid is prepared using the polymer particles and an arbitrary solvent (a dispersion medium that is used to prepare the solid electrolyte composition, for example, heptane) in a 20 ml sample bottle by means of dilution. The diluted dispersion specimen is irradiated with 1 kHz ultrasonic waves for 10 minutes and then immediately used for testing. Data capturing is carried out 50 times using this dispersion liquid specimen, a laser diffraction/scattering-type particle size distribution measurement instrument LA-920 (trade name, manufactured by Horiba Ltd.), and a silica cell for measurement at a temperature of 25° C., and the obtained volume-average particle diameter is considered as the average particle diameter. Regarding other detailed conditions and the like, the description of JIS Z8828:2013“Particle size analysis-Dynamic light scattering” is referred to as necessary. Five specimens are produced per level, and the average values thereof are employed.

Meanwhile, the average particle diameter can be measured from the produced all-solid state secondary battery by, for example, disassembling the battery, peeling the electrodes, measuring the average particle diameters of the electrode materials according to the above-described method for measuring the average particle diameter of the polymer particles, and subtracting the measurement value of the average particle diameter of particles other than the polymer particles which has been measured in advance.

The structure of the polymer particles is not particulary limited as long as the polymer particles are organic polymer particles. Examples of resins constituting the organic polymer particles include the resins described as the resins constituting the binder, and the preferred resins are also applicable.

The shape of the polymer particles is not limited, as long as the polymer particles maintain a solid form. The polymer particles may be mono-dispersed or poly-dispersed. The polymer particles may have a truly spherical shape or a flat shape and, furthermore, may have an irregular shape. The surfaces of the polymer particles may form a flat shape or an uneven shape. The polymer particles may have a core-shell structure, and the core (inner core) and the shell (outer shell) may be constituted of the same material or different materials. In addition, the polymer particles may be hollow particles, and the porosity is not limited.

The polymer particles can be synthesized using a method in which monomer particles are polymerized in the presence of a surfactant, an emulsifier, or a dispersant or a method in which the polymer particles are precipitated in a crystalline shape as the molecular weight increases.

In addition, an existing method in which polymers are mechanically crushed or a method in which a polymer solution is re-precipitated into a fine particle shape may also be used.

The polymer particles may be commercially available products or the oily latex-shape polymer particles described in JP2015-88486A and WO2015-046314A.

Regarding the glass transition temperature of the binder, the upper limit is preferably 50° C. or lower, more preferably 0° C. or lower, and most preferably −20° C. or lower. The lower limit is preferably −100° C. or higher, more preferably −70° C. or higher, and most preferably −50° C. or higher.

The glass transition temperature (g) is measured using a dried specimen and a differential scanning calorimeter “X-DSC7000” (trade name, SII•NanoTechnology Inc.) under the following conditions. The glass transition temperature of the same specimen is measured twice, and the measurement result in the second measurement is employed.

Atmosphere of the measurement chamber: Nitrogen (50 mL/min)

Temperature-increase rate: 5° C./min

Measurement-start temperature: −100° C.

Measurement-end temperature: 200° C.

Specimen pan: Aluminum pan

Mass of the measurement specimen: 5 mg

Calculation of Tg: Tg is calculated by rounding off the middle temperature between the declination-start point and the declination-end point in the DSC chart to the integer.

The polymer (preferably the polymer particles) constituting the binder that is used in the present invention preferably has a moisture concentration of 100 ppm (mass-based) and Tg of 100° C. or lower.

In addition, the polymer constituting the binder that is used in the present invention may be dried by being crystallized or may be used in a polymer solution form. The amount of a metal-based catalyst (tin, titanium, or bismuth catalyst which is an urethanization or polyesterification catalyst) is preferably small. The concentration of metal in copolymers is preferably set to 100 ppm (mass-based) by decreasing the amount of the metal during polymerization or removing the catalyst by means of crystallization.

The solvent that is used for the polymerization reaction of the polymer is not particularly limited. Meanwhile, solvents that do not react with the inorganic solid electrolyte or the active materials and furthermore do not decompose the inorganic solid electrolyte or the active materials are desirably used. For example, it is possible to use hydrocarbon-based solvents (toluene, heptane, and xylene), ester-based solvents (ethyl acetate and propylene glycol monomethyl ether acetate), ether-based solvents (tetrahydrofuran, dioxane, and 1,2-diethoxyethane), ketone-based solvents (acetone, methyl ethyl ketone, and cyclohexanone), nitrile-based solvents (acetonitrile, propionitrile, butyronitrile, and isobutyronitrile), and halogen-based solvents (dichloromethane and chloroform).

The mass average molecular weight of the polymer constituting the binder that is used in the present invention is preferably 10,000 or more, more preferably 20,000 or more, and still more preferably 50,000 or more. The upper limit is preferably 1,000,000 or less, more preferably 200,000 or less, and still more preferably 100,000 or less.

In the present invention, the molecular weight of the polymer refers to the mass average molecular weight unless particularly otherwise described. The mass average molecular weight can be measured as the polystyrene-equivalent molecular weight by means of GPC. At this time, the polystyrene-equivalent molecular weight is detected as RI using a GPC apparatus HLC-8220 (manufactured by Tosoh Corporation) and G3000HXL+G2000HXL as columns at a flow rate at 23° C. of 1 mL/min. An eluent can be selected from tetrahydrofuran (THF), chloroform, N-methyl-2-pyriolidone (NMP), and m-cresol/chloroform (manufactured by Shonanwako Junyaku KK), and THF is used in a case in which the polymer needs to be dissolved.

In a case in which favorable interface resistance-reducing and maintaining properties are taken into account when the binder is used in all-solid state secondary batteries, the concentration of the binder in the solid electrolyte composition is preferably 0.01% by mass or more, more preferably 0.1% by mass or more, and still more preferably 1% by mass or more with respect to 100% by mass of the solid components. From the viewpoint of battery characteristics, the upper limit is preferably 10% by mass or less, more preferably 5% by mass or less, and still more preferably 3% by mass or less.

In the present invention, the mass ratio [(the mass of the inorganic solid electrolyte and the mass of the electrode active materials)/the mass of the binder] of the total mass of the inorganic solid electrolyte and the electrode active materials that are added as necessary to the mass of the binder is preferably in a range of 1,000 to 1. This ratio is more preferably 500 to 2 and still more preferably 100 to 10.

(Dispersant)

The solid electrolyte composition of the present invention also preferably contains a dispersant. The addition of a dispersant suppresses the agglomeration of the electrode active materials or the inorganic solid electrolyte even in a case in which the concentration of any one the electrode active materials or the inorganic solid electrolyte is high and enables the formation of uniform electrode layers hereinafter, the scope of the electrode layers includes both the negative electrode active material layer and the positive electrode active material layer) and the inorganic electrolyte layer. The addition of a dispersant is also effective for improvement in output density.

The dispersant is a compound having a molecular weight of 200 or more and less than 3,000 and preferably contains at least one functional group selected from a group of functional groups represented by a group of functional groups (A), an alkyl group having 8 or more carbon atoms, and an aryl group having 10 or more carbon atoms in the same molecule.

Group of functional groups (A): acidic groups, groups having a basic nitrogen atom, (meth)acrylic groups, (meth)acrylamide groups, alkoxysilyl groups, epoxy groups, oxetanyl groups, isocyanate groups, cyano groups, thiol groups, and hydroxyl groups

The molecular weight of the dispersant is preferably 300 or more and less than 2,000 and more preferably 500 or more and less than 1,000. In a case in which the molecular weight is less than the above-described upper limit value, particles do not easily agglomerate together, and it is possible to effectively suppress a decrease in output. In addition, in a case in which the molecular weight is the above-described lower limit value or more, the dispersant does not easily volatilize in a stage in which a solid electrolyte composition slurry is applied and dried.

The content of the dispersant is preferably 0.01% to 10% by mass, more preferably 0.1% to 5% by mass, and still more preferably 1% to 3% by mass of the total solid components of the solid electrolyte composition of the present invention.

(Lithium salt)

The solid electrolyte composition of the present invention also preferably contains a lithium salt.

The lithium salt is preferably a lithium salt that is ordinarily used in this kind of products and is not particularly limited, and preferred examples thereof include the following salts.

(L-1) Inorganic lithium salts: inorganic fluoride salts such as LiPF₆, LiBF₄, LiAsF₆, and LiSb₆; perhalogen acids such as LiClO₄, LiBrO₄, and LiIO₄; inorganic chloride salts such as LiAlCl₄; and the like

(L-2) Fluorine-containing organic lithium salts: perfluoroalkanesulfonate salts such as LiCF₃SO₃; perfluoroalkanesulfonylimide salts such as LiN(CF₃SO₂)₂, LiN(CF₃CF₂SO₂)₂, Lin(FSO₂)₂, LiN(CF₃SO₂)(C₄F₉SO₂); perfluoroalkanesulfonyl methide salts such as LiC(CF₃SO₂)₃; fluoroalkyl fluorophosphates salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃]; and the like

(L-3) Oxalate borate salts: lithium bis(oxalato)borate, lithium difluorooxalatoborate, and the like

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferred, and lithium imide salts such as LiPF₆, LiBF₄, LiN(Rf¹SO₂)₂, LiN(FSO₂)₂, and LiN(Rf¹SO₂)(Rf²SO₂) are more preferred. Here, Rf¹ and Rf² each independently represent a perfluoroalkyl group.

Meanwhile, these lithium salts may be used singly or two or more lithium salts may be arbitrarily combined together.

The content of the lithium salt is preferably 0 parts by mass or more and more preferably 5 parts by mass or more with respect to 100 parts by mass of the solid electrolyte. The upper limit is preferably 50 parts by mass or less and more preferably 20 parts by mass or less.

(Auxiliary Conductive Agent)

The solid electrolyte composition of the present invention also preferably contains an auxiliary conductive agent. As the auxiliary conductive agent, auxiliary conductive agents that are known as ordinary auxiliary conductive agents can be used. The auxiliary conductive agent may be, for example, graphite such as natural graphite or artificial graphite, carbon black such as acetylene black, Ketjen black, or furnace black, irregular carbon such as needle cokes, a carbon fiber such as a vapor-grown carbon fiber or a carbon nanotube, or a carbonaceous material such as graphene or fullerene and also may be metal powder or a metal fiber of copper, nickel, or the like, and a conductive macromolecule such as polyaniline, polypyrrole, polythiophene, polyacetylene, or a polyphenylene derivative may also be used. In addition, these auxiliary conductive agents may be used singly or two or more auxiliary conductive agents may be used.

(Positive Electrode Active Material)

Next, a positive electrode active material that is used in the solid electrolyte composition for forming the positive electrode active material layer in the all-solid state secondary battery of the present invention (hereinafter, also referred to as the composition for a positive electrode) will be described. The positive electrode active material is preferably a positive electrode active material capable of reversibly intercalating and deintercalating lithium ions. The above-described material is not particularly limited and may be transition metal oxides, elements capable of being complexed with Li such as sulfur, or the like. Among these, transition metal oxides are preferably used, and the transition metal oxides more preferably have one or more elements selected from Co, Ni, Fe, Mn, Cu, and V as transition metal.

Specific examples of the transition metal oxides include transition metal oxides having a bedded salt-type structure (MA), transition metal oxides having a spinel-type structure (MB), lithium-containing transition metal phosphoric oxide compounds (MC), lithium-containing transition metal halogenated phosphoric acid compounds (MD), lithium-containing transition metal silicon oxide compounds (ME), and the like.

Specific examples of the transition metal oxides having a bedded salt-type structure (MA) include LiCo0₂ (lithium cobalt oxide [LCO]), LiNi₂O₂ (lithium nickelate), LiNi_{0.85}Co_{0.10}Al_{0.05}O₂ (lithium nickel cobalt aluminum oxide [NCA]), LiNi_{0.33}Co_{0.33}Mn_{0.33}O₂ (lithium nickel manganese cobalt oxide [NMC]), and LiNi_{0.5}Mn_{0.5}O₂ (lithium manganese nickelate).

Specific examples of the transition oxides having a spinel-type structure (MB) include LiCoMnO₄, Li₂FeMn₃O₈, Li₂CuMn₃O₈, Li₂CrMn₃O₈, and Li₂NiMn₃O₈.

Examples of the lithium-containing transition metal phosphoric oxide compounds (MC) include olivine-type iron phosphate salts such as LiFePO₄ and Li₃Fe₂(PO₄)₃, iron pyrophosphates such as LiFeP₂O₇, cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicon oxide compounds (ME) include Li₂FeSiO₄, Li₂MnSiO₄, Li₂CoSiO₄, and the like.

The volume-average particle diameter (circle-equivalent average particle diameter) of the positive electrode active material that can be used in the solid electrolyte composition of the present invention is not particularly limited. Meanwhile, the volume-average particle diameter is preferably 0.1 μm to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter of positive electrode active material particles can be measured using a laser diffraction/scattering-type particle size distribution measurement instrument LA-920 (trade name, manufactured by Horiba Ltd.).

The concentration of the positive electrode active material is not particularly limited, but is preferably 10% to 90% by mass and more preferably 20% to 80% by mass with respect to 100% by mass of the solid components in the composition for a positive electrode.

The positive electrode active material may be used singly or two or more positive electrode active materials may be used in combination.

(Negative Electrode Active Material)

Next, a negative electrode active material that is used in the solid electrolyte composition for forming the negative electrode active material layer in the all-solid state secondary battery of the present invention (hereinafter, also referred to as the composition for a negative electrode) will be described. The negative electrode active material is preferably a negative electrode active material capable of reversibly intercalating and deintercalating lithium ions. The above-described material is not particularly limited, and examples thereof include carbonaceous materials, metal oxides such as tin oxide and silicon oxide, metal complex oxides, a lithium single body or lithium alloys such as lithium aluminum alloys, metals capable of forming alloys with lithium such as Sn, Si, and In and the like. Among these, carbonaceous materials or metal complex oxides are preferably used in terms of reliability. In addition, the metal complex oxides are preferably capable of absorbing and deintercalating lithium. The materials are not particularly limited, but preferably contain titanium and/or lithium as constituent components from the viewpoint of high-current density, charging and discharging characteristics.

The carbonaceous material that is used as the negative electrode active material is a material substantially consisting of carbon. Examples thereof include petroleum pitch, carbon black such as acetylene black (AB), natural graphite, artificial graphite such as highly oriented pyrolytic graphite, and carbonaceous material obtained by firing a variety of synthetic resins such as polyacrylonitrile (PAN)-based resins or furfuryl alcohol resins. Furthermore, examples thereof also include a variety of carbon fibers such as PAN-based carbon fibers, cellulose-based carbon fibers, pitch-based carbon fibers, vapor-grown carbon fibers, dehydrated polyvinyl alcohol (PVA)-based carbon fibers, lignin carbon fibers, glassy carbon fibers, and active carbon fibers, mesophase microspheres, graphite whisker, flat graphite, and the like.

The metal oxides and the metal complex oxides being applied as the negative electrode active material are particularly preferably amorphous oxides, and furthermore chalcogenides which are reaction products between a metal element and an element belonging to Group XVI of the periodic table are also preferably used. The amorphous oxides mentioned herein refer to oxides having a broad scattering band having a peak of a 2θ value in a range of 20° to 40° in an X-ray diffraction method in which CuKα rays are used and may have crystalline diffraction lines. The highest intensity in the crystalline diffraction line appearing at the 2θ value of 40° or more and 70° or less is preferably 100 times or less and more preferably five times or less of the diffraction line intensity at the peak of the broad scattering line appearing at the 2θ value of 20° or more and 40° or less and particularly preferably does not have any crystalline diffraction lines.

In a compound group consisting of the amorphous oxides and the chalcogenides, amorphous oxides of semimetal elements and chalcogenides are more preferred, and elements belonging to Groups XIII (IIIB) to XV (VB) of the periodic table, oxides consisting of one element or a combination of two or more elements of Al, Ga, Si, Sn, Ge, Pb, Sb, and Bi, and chalcogenides are particularly preferred. Specific examples of preferred amorphous oxides and chalcogenides include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂Sb₂S₃, Sb₂S₅, and SnSiS₃. In addition, these amorphous oxides may be complex oxides with lithium oxide, for example, Li₂SnO₂.

The volume-average particle diameter of the negative electrode active material is preferably 0.1 μm to 60 μm. In order to provide a predetermined particle diameter, an arbitrary crusher or classifier is used. For example, a mortar, a ball mill, a sand mill, an oscillatory ball mill, a satellite ball mill, a planetary ball mill, a swirling airflow-type jet mill, a sieve, or the like is preferably used. During crushing, it is also possible to carry out wet-type crushing in which water or an organic solvent such as methanol is made to coexist as necessary. In order to provide a desired particle diameter, classification is preferably carried out. The classification method is not particularly limited, and it is possible to use a sieve, a wind powder classifier, or the like depending on the necessity. Both of dry-type classification and wet-type classification can be carried out. The volume-average particle diameter of negative electrode active material particles can be measured using the same method as the method for measuring the volume-average particle diameter of the positive electrode active material.

The negative electrode active material also preferably contains titanium atoms. More specifically, Li₄Ti₅O₁₂ is preferred since the volume fluctuation during the absorption and emission of lithium ions is small and thus the high-speed charging and discharging characteristics are excellent and the deterioration of electrodes is suppressed, whereby it becomes possible to improve the service lives of lithium ion secondary batteries.

The concentration of the negative electrode active material is not particularly limited, but is preferably 10 to 80% by mass and more preferably 20 to 70% by mass with respect to 100% by mass of the solid components in the composition for a negative electrode.

The negative electrode active material may be used singly or two or more negative electrode active materials may be used in combination.

The surfaces of the positive electrode active material and the negative electrode active material may be coated with another metal oxide. Examples of surface-coating agents include metal oxides which contain Ti, Nb, Ta, W, Zr, Si, and the like and may further contain Li.

Examples of the method for coating the surfaces or surface-coated positive electrode active materials or negative electrode active materials will be described below, and those can be appropriately used in the present invention.

For example, positive electrode active materials having a coated portion consisting of a lithium niobate-based compound formed on the surface of an oxide positive electrode active material and manufacturing methods therefore are described in JP2010-225309A and a non-patent document Narumi Ohta et al., “LiNbO₃-coated LiCoO₂ as cathode material for all-solid-state lithium secondary batteries”, Electrochemistry Communications 9 (2007) 1486-1490.

In addition, lithium metal oxides represented by Li_{Y}XO_{Z} (in the formula, X represents Co, Mn, or Ni, and Y and Z respectively represent integers of 1 to 10) which have a surface coated with a coating material such as spinel titanate, a tantalum-based oxide, or a niobium-based oxide (specifically, Li₄Ti₅O₁₂, LiTaO₃, LiNbO₃, LiAlO₂, Li₂ZrO₃, Li₂WO₄, Li₂TiO₃, Li₂B₄O₇, Li₃PO₄, Li₂MoO₄, LiBO₂, or the like) are described in JP2008-103280A.

Electrode materials for all-solid state secondary batteries which have a surface treated with sulfur and/or phosphorous are described in JP2008-027581A.

In addition, oxide positive electrode active materials having a surface supported by a lithium chloride are described in JP2001-052733A.

(Dispersion Medium)

The solid electrolyte composition of the present invention contains a dispersion medium. The dispersion medium needs to be capable of dispersing the respective components described above, and specific examples thereof include the following media.

Examples of alcohol compound solvents include methyl alcohol, ethyl alcohol, 1-propyl alcohol, 2-propyl alcohol, 2-butanol, ethylene glycol, propylene glycol, glycerin, 1,6-hexanediol, cyclohexanediol, sorbitol, xylitol, 2-methyl-2,4-pentanediol, 1,3-butanediol, and 1,4-butanediol.

Examples of ether compound solvents include alkylene glycol alkyl ethers (ethylene glycol monomethyl ether, ethylene glycol monobutyl ether, diethylene glycol, dipropylene glycol, propylene glycol monomethyl ether, diethylene glycol monomethyl ether, triethylene glycol, polyethylene glycol, propylene glycol monomethyl ether, dipropylene glycol monomethyl ether, tripropylene glycol monomethyl ether, diethylene glycol monobutyl ether, and the like), dimethyl ether, diethyl ether, diisopropyl ether, dibutyl ether, tetrahydrofuran, and dioxane.

Examples of amide compound solvents include N,N-dimethylformamide, 1-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropanamide, and hexamethylphosphorie triamide.

Examples of amino compound solvents include triethylamine, diisopropylethylamine, and tributylamine.

Examples of ketone compound solvents include acetone, methyl ethyl ketone, methyl isobutyl ketone, and cyclohexanone.

Examples of aromatic compound solvents include benzene, toluene, xylene, mesitylene, chlorobenzene, dichlorobenzene, and nitrobenzene.

Examples of aliphatic compound solvents include hexane,heptane, octane, and decane.

Examples of nitrile compound solvents include acetonitrile, propionitrile, and butyronitrile.

The boiling; point of the dispersion medium at normal pressure (one atmosphere) is preferably 30° C. or higher and more preferably 50° C. or higher. The upper limit is preferably 250° C. or lower and more preferably 220° C. or lower.

In a case in which the boiling point is in the preferred range described above, it is possible to dry the dispersion medium while maintaining the structure of the self-assembled nanofibers in the production of all-solid state secondary batteries. Meanwhile, even dispersion media having a boiling point that is equal to or higher than the drying temperature may be used as long as the dispersion media are volatile and capable of maintaining the structure of the self-assembled nanofibers.

The dispersion media may be used singly or two or more dispersion media may be used in combination.

In the present invention, the dispersion medium is preferably a hydrocarbon-based solvent since the hydrocarbon-based solvent is highly stable with respect to the inorganic solid electrolyte, and examples the hydrocarbon-based solvent include the aromatic compound solvents and the aliphatic compound solvents. Specifically, dibutyl ether, toluene, heptane, xylene, mesithylene, and octane are preferably used.

The content of the dispersion medium is preferably 20 to 80 parts by mass, more preferably 30 to 70 parts by mass, and still more preferably 40 to 65 parts by mass in 100 parts by mass of the total mass of the solid electrolyte composition.

The dispersion medium may be a dispersion medium capable of dissolving part or all of the inorganic solid electrolyte.

<Collector (Metal Foil)>

The collectors of positive and negative electrodes are preferably an electron conductor that does not chemically change. The collector of the positive electrode is preferably a collector obtained by treating the surface of an aluminum or stainless steel collector with carbon, nickel, titanium, or silver in addition to an aluminum collector, a stainless steel collector, a nickel collector, a titanium collector, or the like, and, among these, an aluminum collector and an aluminum alloy collector are more preferred. The collector of the negative electrode is preferably an aluminum collector, a copper collector, a stainless steel collector, a nickel collector, or a titanium collector and more preferably an aluminum collector, a copper collector, or a copper alloy collector.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 pm to 500 μm. In addition, the surface of the collector is preferably provided with protrusions and recesses by means of a surface treatment.

<Production of All-Solid State Secondary Battery>

The all-solid state secondary battery may be produced using an ordinary method. Specific examples thereof include a method in which the solid electrolyte composition of the present invention is applied onto a metal foil which serves as the collector, thereby producing an electrode sheet for an all-solid state secondary battery on which a coated film is formed.

In the all-solid state secondary battery of the present invention, the electrode layers contain active materials. From the viewpoint of improving ion conductivity, the electrode layers preferably contain the inorganic solid electrolyte. In addition, from the viewpoint of improving the bonding properties between solid particles,between the electrode layers and the solid electrolyte layer, between the electrode layers and the collector, and the like, the electrode layers preferably contain the low-molecular-weight gellant and also preferably contain the binder.

The solid electrolyte layer contains the low-molecular-weight gellant and the inorganic solid electrolyte. From the viewpoint of improving the bonding properties between solid particles and between layers, the solid electrolyte layer also preferably contains the binder.

In the present invention, it is preferable that the solid electrolyte composition in which the low-molecular-weight gellant is dissolved or the solid electrolyte composition in which gel is dispersed is applied onto a metal foil and then cooled in the air so as to form self-assembled nanofibers, a film is formed by carry out a drying treatment after the progress of gelatinization, the dispersion medium is volatilized, and a structure in which solid particles of the solid electrolyte or the active materials twist with the network-shaped self-assembled nanofibers is formed.

Hereinafter, the detail will be described.

i) Dissolution of Low-Molecular-Weight Gellant and Dispersion of Gel

Examples of the method for dissolving the low-molecular-weight gellant include a method in which the low-molecular-weight gellant is ordinarily heated, but a method in which the low-molecular-weight gellant is dissolved using heat energy generated from collision such as mechanical dispersion or the like is preferred from the viewpoint of decreasing the number of manufacturing processes and saving energy. The solid electrolyte composition in which the low-molecular-weight gellant is dissolved is preferably applied onto a metal foil before gelatinization from the viewpoint of easy handling.

Meanwhile, the low-molecular-weight gellant may be dissolved by dissolving the powder (solid) of the low-molecular-weight gellant in the solid electrolyte composition by means of mechanical dispersion or by adding an appropriate solvent that has been gelatinized by the low-molecular-weight gellant in advance during the preparation of the solid electrolyte composition by means of mechanical dispersion.

In a case in which the solid electrolyte composition of the present invention is prepared, mechanical dispersion or crushing may be carried out. In such a case, it is possible to disperse or crush the inorganic solid electrolyte or gel in the solid electrolyte composition, and, for example, mechanical dispersion is preferred. In the mechanical dispersion, a ball mill, a beads a planetary mixer, a blade mixer, a roll mill, a kneader, a disc mill, a rotary homogenizer, an ultrasonic homogenizer, or the like is used.

In the case of using a ball mill for dispersion, examples of the material of balls in the ball mill include agate, sintered alumina, tungsten carbide, chrome steel, stainless steel, zirconia, plastic polyamides, nylon, silicon nitride, Teflon (registered trademark), and the like.

In the preparation of the solid electrolyte composition by means of mechanical dispersion, in a case in which balls of a material having high hardness (for example, zirconia) are used or the rotation speed during stirring is fast (for example, 300 to 700 rpm), heat energy of collision is high, and thus the dissolution of the low-molecular-weight gellant or the re-dissolution of gel may occur. Meanwhile, in a case in which balls of a material having low hardness (for example, Teflon (registered trademark)) are used or the rotation speed during stirring is slow (for example, 50 to 200 rpm), the re-dissolution of gel (hydrogen bonds in the formed nanofibers disappear, the molecular weight of the nanofibers decreases, and the nanofibers are dissolved) does not occur, and it is possible to decrease the viscosity (by cutting some hydrogen bonds in the nanofibers) while maintaining the gel form. Materials to be used can be appropriately adjusted depending on the kind of the low-molecular-weight gellant being used, the solvent, or the dispersion medium.

ii) Coating

For example, a composition which serves as a positive electrode material is applied onto a metal foil which is a positive electrode collector so as to form a positive electrode active material layer, thereby producing a positive electrode sheet for a battery. The solid electrolyte composition of the present invention is applied onto the positive electrode active material layer, thereby forming a solid electrolyte layer. Furthermore a composition which serves as a negative electrode material is applied onto the solid electrolyte layer, thereby forming a negative electrode active material layer. A collector for the negative electrode (metal foil) is overlaid on the negative electrode active material layer, whereby it is possible to obtain a structure of an all-solid state secondary battery in which the solid electrolyte layer is sandwiched between a positive electrode layer and a negative electrode layer. In addition, the composition may be applied in different orders.

iii) Cooling in air and drying

Meanwhile, the respective compositions described above may be applied using an ordinary method. At this time, the composition for forming the positive electrode active material layer, the composition for forming the inorganic solid electrolyte layer, and the composition for forming the negative electrode active material layer may be dried after being applied respectively or may be dried after being applied into multiple layers. The drying treatment is preferably carried out after the self-assembled nanofibers are formed by cooling the composition in the air (by leaving the composition to stand) and gelatinize. The time of cooling in the air is not particularly limited, but the composition is preferably dried in the air for five minutes. In addition, the upper limit of the time of drying in the air is not particularly limited; however, realistically, is preferably three days or shorter.

In addition, the respective compositions described above are preferably stirred or made fluid before being applied. In such a case, in a case in which the compositions are cooled in the air or left to stand after being applied, molecules are easily arranged, gelatinization proceeds rapidly, and the time regarding manufacturing steps can be shortened.

The drying temperature is not particularly limited. Meanwhile, the lower limit is preferably 30° C. or higher and more preferably 60° C. or higher, and the upper limit is preferably 200° C. or lower and more preferably 150° C. or lower. In a case in which the compositions are heated in the above-described temperature range, it is possible to remove the dispersion medium while the low-molecular-weight gellant forms the self-assembled nanofibers, and it is possible to form a solid state while maintaining a structure in which the inorganic solid electrolyte or the active materials twist with the network-shaped self-assembled nanofibers.

[Usages of All-Solid State Secondary Battery]

The all-solid state secondary battery of the present invention can be applied to a variety of usages. Application aspects are not particularly limited, and, in the case of being mounted in electronic devices, examples thereof include notebook computers, pen-based input personal computers, mobile personal computers, e-book players, mobile phones, cordless phone handsets, pagers, handy terminals, portable faxes, mobile copiers, portable printers, headphone stereos, video movies, liquid crystal televisions, handy cleaners, portable CDs, mini discs, electric shavers, transceivers, electronic notebooks, calculators, portable tape recorders, radios, backup power supplies, memory cards, and the like. Additionally, examples of consumer usages include automobiles, electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

Among these, the all-solid state secondary battery is preferably applied to applications for which a high capacity and high-rate discharging characteristics are required. For example, in electricity storage facilities in which an increase in the capacity is expected in the future, it is necessary to satisfy both high safety, which is essential, and furthermore, the battery performance. In addition, in electric vehicles mounting high-capacity secondary batteries and domestic usages in which batteries are charged out every day, better safety is required against overcharging. According to the present invention, it is possible to preferably cope with the above-described use aspects and exhibit excellent effects.

According to the preferred embodiment of the present invention, individual application forms as described below are derived.

[1] The solid electrolyte composition of the present invention including active materials capable of intercalating and deintercalating ions of metals belonging to Group I or II of the periodic table (compositions for a positive electrode or negative electrode).

[2] Electrode sheets for an all-solid state secondary battery having a positive electrode active material layer, a solid electrolyte layer, and a negative electrode active material layer in this order, in which any one layer of the positive electrode active material layer, the solid electrolyte layer, and the negative electrode active material layer contains a low-molecular-weight gellant and an inorganic solid electrolyte having conductivity of ions of metals belonging to Group I or II of the periodic table.

[3] All-solid state secondary batteries constituted using electrode sheet for an all-solid state secondary battery.

[4] Methods for manufacturing an electrode sheet for an all-solid state secondary battery in which the solid electrolyte composition is applied onto a metal foil, the solid electrolyte composition is gelatinized, and then a film is formed.

[5] Methods for manufacturing an all-solid state secondary battery in which state secondary batteries are manufactured using the method for manufacturing an all-solid state secondary battery.

Meanwhile, examples of the methods in which the solid electrolyte composition is applied onto a metal foil include coating (wet-type coating, spray coating, spin coating, slit coating, stripe coating, bar coating, or dip coating), and wet-type coating is preferred.

In addition, in the electrode sheets for an all-solid state secondary battery and the all-solid state secondary batteries, a structure in which the low-molecular-weight gellant forms self-assembled nanofibers, and the solid electrolyte or the active materials twist together in a network-shaped three-dimensional structure formed by the self-assembled nanofibers is preferred.

Among the application form of [2], an electrode sheet for an all-solid state secondary battery in which all of the layers contain the low-molecular-weight gellant and the inorganic solid electrolyte having conductivity of ions of metals belonging to Group I or II if the periodic table is preferred.

In addition, examples of the preferred embodiment of the present invention also include individual application forms below. Particularly, examples of a method for preparing a solid electrolyte composition in which an appropriate solvent that has been gelatinized by the low-molecular-weight gellant in advance is used include application forms of [6] to [9] below.

[6] Solid electrolyte compositions in which part or all of an inorganic solid electrolyte having conductivity of ions of metals belonging to Group I or II of the periodic table is dissolved.

[7] Mixtures for a solid electrolyte composition containing a first inorganic solid electrolyte having conductivity of ions of metals belonging to Group I or II of the periodic table, a dispersion medium, and gel, in which the gel includes at least a low-molecular-weight gellant and a solvent.

Here, the gel may include a second inorganic solid electrolyte having conductivity of ions of metals belonging to Group I or II of the periodic table and/or an electrode active material, and the second inorganic solid electrolyte may be dispersed or dissolved in the gel.

[8] Methods for manufacturing a solid electrolyte composition, in which the mixture for a solid electrolyte composition of [7] is mixed.

[9] Methods for manufacturing a solid electrolyte composition containing a low-molecular-weight gellant, a first inorganic solid electrolyte having conductivity of ions of metals belonging to Group I or II of the periodic table, and a dispersion medium, the methods including Steps (i) to (iii)

Step (i): a step of heating a pre-liquid mixture a containing the low-molecular-weight gellant and a solvent and preparing a liquid mixture a in which the low-molecular-weight gellant is dissolved,

Step (ii): a step of cooling the liquid mixture a and forming gel, and

Step (iii): a step of mixing the gel, the first inorganic solid electrolyte having conductivity of ions of metals belonging to Group I or II of the periodic table, and the dispersion medium and preparing a solid electrolyte composition.

Here, the methods may also have a step of adding the second inorganic solid electrolyte having conductivity of ions of metals belonging to Group I or II of the periodic table and/or the electrode active material to the pre-liquid mixture a, the liquid mixture a, or the gel, and the second inorganic solid electrolyte may be dispersed or dissolved in the gel. Meanwhile, the methods preferably has the step of adding the second inorganic solid electrolyte to the liquid mixture a.

Here, the gel that is formed in Step (ii) specifically refers to gel in which a solvent is gelatinized by a low-molecular-weight gellant.

In addition, the mixtures for a solid electrolyte composition of [7] and the solid electrolyte compositions of [9] (hereinafter, also referred to as the mixtures and the compositions) may contain, in addition to the inorganic solid electrolyte that is directly added to the mixtures and the compositions (in the present invention, also referred to as the first inorganic solid electrolyte), an inorganic solid electrolyte that may be added to the gel of [7] and the pre-liquid mixture a, the liquid mixture a, or the gel of [9] (in the present invention, also referred to as the gel and the liquid mixture a) (in the present invention, also referred to as the second inorganic solid electrolyte).

The second inorganic solid electrolyte may be identical to or different from the first inorganic solid electrolyte, and the description of the inorganic solid electrolyte in the above-described section of the solid electrolyte composition can be preferably applied to both the first and second inorganic solid electrolytes.

Unless particularly otherwise described, the description of the low-molecular-weight gellant and the dispersion medium in the above-described section of the solid electrolyte composition can be preferably applied to the low-molecular-weight gellant and dispersion medium, respectively. In addition, unless particularly otherwise described, the description of a solvent_{gel} in the section of complexed gel described below can be preferably applied to the solvent.

In a case in which solid electrolyte compositions obtained using the manufacturing methods of [8] and [9] contain both the first inorganic solid electrolyte that is directly added to the mixtures and the compositions and the second inorganic solid electrolyte that is added to the gel and the liquid mixture a, all-solid state secondary batteries produced using a solid electrolyte composition to be obtained are preferred due to their lower resistance and more favorable cycle characteristics.

This is assumed to result from the following reason.

That is, generally, first inorganic solid electrolyte particles are considered to be hard and have pores thereamong. In contrast, the inorganic solid electrolyte that may be dispersed or dissolved in the gel (second inorganic solid electrolyte) is considered to be flexible and fluid and be capable of filling the pores among the first inorganic solid electrolyte particles. In addition, it is considered that the second inorganic solid electrolyte is surrounded by supramolecular nanofibers in which the low-molecular-weight gellant forming the gel forms a network, and thus the deformation and peeling of the inorganic solid electrolyte particles caused by the expansion and contraction of the electrode active material during charging and discharging are suppressed.

In this case, the content ratio (the first inorganic solid electrolyte:the second inorganic solid electrolyte) of the second inorganic solid electrolyte to the first inorganic solid electrolyte in the mixtures and the compositions is preferably 80:20 to 99.9:0.1, more preferably 85:15 to 99:1, and still more preferably 90:10 to 97:3 in mass ratio.

Solid electrolyte compositions obtained using the methods of [8] and [9] may also contain the low-molecular-weight gellant that is directly added to the mixtures and the compositions in addition to the low-molecular-weight gellant that is added to the gel and the liquid mixture a.

In addition, the mixtures for a solid electrolyte composition, the gel, and the solid electrolyte compositions of [7] to [9] may appropriately contain an appropriate amount of the additives such as the binder, the dispersant, the lithium salt, and the auxiliary conductive agent described in the section of the solid electrolyte composition in addition to the components such as the low-molecular-weight gellant.

The solid electrolyte compositions of [6] are obtained, for example, using a dispersion medium that dissolves part or all of the inorganic solid electrolyte. In addition, in a case in which a dispersion medium and/or solvent that dissolve part or all of the inorganic solid electrolyte are used as the dispersion medium and/or the solvent of [7] and [9], it is also possible to prepare the solid electrolyte compositions of [6].

To the dispersion medium and/or solvent that dissolve the inorganic solid electrolyte, the description of the solvent_{gel} in the section of complexed gel described below can be preferably applied.

In the mixtures for a solid electrolyte composition of [7] and the manufacturing methods of [9], the ratio between the solvent and the dispersion medium is not particularly limited, but the content ratio (the solvent:the dispersion medium) of the dispersion medium to the solvent is preferably 50:50 to 95:5, more preferably 60:40 to 93:7, and still more preferably 70:30 to 90:10 in mass ratio.

The manufacturing methods of [9] are not particularly limited as long as the manufacturing method includes Steps (i) to (iii).

To Steps (i) and (ii), the description of Steps (i-A) and (ii-A) in a method for manufacturing complexed gel described below can be preferably applied.

In addition, Step (iii) is not particularly limited as long as the gel formed in Step (ii) is mixed into other components (the inorganic solid electrolyte, the dispersion medium, and the like) in the solid electrolyte composition. The gel needs to be uniformly dispersed in the solid electrolyte composition by mixing, and the gel may be dissolved in the solid electrolyte composition or be present in a gel form.

In a case in which the gel is present in a gel form, the viscosity may vary before and after the mixing. Generally, in a case in which energy is applied to gel that has been generated in advance in heating and cooling steps through milling mixing or the like, the viscosity decreases. This is considered to be because the lengths of supramolecular nanofibers forming the gel become short and the number of twists between supramolecular chains decreases. Furthermore, in a case in which high energy is applied, the gel may be dissolved. In a case in which the gel is included in the solid electrolyte composition, the effects of the present invention become more significant, and thus the solid electrolyte composition preferably has a viscosity that is higher than that of solid electrolyte compositions in which the low-molecular-weight gellant is fully dissolved. That is, irrespective of the shape or the viscosity varying before and after mixing, the low-molecular-weight gellant is preferably present in a gel form.

As the method for dissolving and dispersing the gel, the description of i) the dissolution of the low-molecular-weight gellant described in the section of the production of an all-solid state secondary battery is preferably applied.

Solid electrolyte compositions obtained through Steps (i) to (iii) can be preferably used as the solid electrolyte composition that is applied onto the metal foil which serves as the collector in the production of an all-solid state secondary battery.

To the manufacturing methods of [8], the description of Step (iii) of [9] can be preferably applied by considering “the gel formed in Step (ii)” as “gel” and “other components in the solid electrolyte composition” as “other components in the mixture (the inorganic solid electrolyte, the dispersion medium, and the like)”.

In the pre-liquid mixture a, the liquid mixture a, and the gel, the content ratio (the low-molecular-weight gellant:the solvent) of the solvent to the low-molecular-weight gellant is preferably 0.1:99.9 to 10:90, more preferably 0.5:99.5 to 5:95, and still more preferably 1:99 to 5:95.

In a case in which the pre-liquid mixture a, the liquid mixture a, and the gel contain the second inorganic solid electrolyte, in the pre-liquid mixture a, the liquid mixture a, and the gel, the content ratio (the low-molecular-weight gellant:the second inorganic solid electrolyte:the solvent) among the low-molecular-weight gellant, the second inorganic solid electrolyte, and the solvent is preferably 0.1 to 10:0.1 to 20:99.8 to 70, more preferably 0.5 to 5:0.5 to 15:99 to 80, and still more preferably 1 to 5:1 to 10:98 to 85.

Here, in a case in which the pre-liquid mixture a, the liquid mixture a, and the gel include components other than the second inorganic solid electrolyte and the low-molecular-weight gellant, the description of the mass content ratio among the low-molecular-weight gellant, the second inorganic solid electrolyte, and the solvent can be preferably applied by considering the total amount including the second inorganic solid electrolyte and other components as the content of the second inorganic solid electrolyte.

In the manufacturing methods of [8] and [9], the content of gel with respect to 100 parts by mass of the total mass of the solid electrolyte composition to be obtained is not particularly limited, but is preferably 20 to 80 parts by mass, more preferably 30 to 70 parts by mass, and still more preferably 40 to 60 parts by mass.

Here the content of “the gel” refers to the mass of at least both the low-molecular-weight gellant (the amount of solid components) and the solvent and, in some cases, the mass of the second inorganic solid electrolyte and the electrode active materials and other components in the gel.

To the content ratio among the components in the mixtures for a solid electrolyte composition of [7], the description of the content ratio of [9] can be preferably applied.

<Complexed Gel>

Complexed gel of the present invention contains a low-molecular-weight gellant (hereinafter, referred to as the low-molecular-weight gellant), a solvent (hereinafter, referred to as the solvent_{gel}), and an inorganic solid electrolyte having conductivity of ions of metals belonging to Group I or II of the periodic table (hereinafter, referred to as the inorganic solid electrolyte_{gel}). Here, the inorganic solid electrolyte_{gel} may be dispersed or dissolved in the complexed gel_{gel}.

Unless particularly otherwise described, to the low-molecular-weight gellant_{gel}, the solvent_{gel}, and the inorganic solid electrolyte_{gel}, the description of the low-molecular-weight gellant, the dispersion medium, and the inorganic solid electrolyte in the above-described section of the solid electrolyte composition can be preferably applied respectively.

In the present invention, the complexed gel containing the low-molecular-weight gellant_{gel}, the solvent_{gel}, and the inorganic solid electrolyte_{gel} specifically refers to gel in which the solvent_{gel} is gelatinized by the low-molecular-weight gellant_{gel} and the inorganic solid electrolyte_{gel} is contained in the gel.

The form of the inorganic solid electrolyte_{gel} can be appropriately prepared using, for example, the solvent_{gel}. For example, in the case of a polar solvent_{gel} such as an amide compound solvent, an alcohol compound solvent, a nitrile compound solvent, or an ether compound solvent, the inorganic solid electrolyte_{gel} can be dissolved in the complexed gel, and, in the case of a non-polar solvent_{gel} such as an aromatic compound solvent, an aliphatic compound solvent, or a halogen-containing solvent, the inorganic solid electrolyte_{gel} can be present a dispersed form in the complexed gel.

In addition, in a case in which the inorganic solid electrolyte_{gel} is a sulfide-based inorganic solid electrolyte, more preferably, it is possible to prepare a form in which the inorganic solid electrolyte_{gel} is dissolved in the solvent_{gel}.

Examples of the halogen-containing solvent include chloroform, dichloromethane, 1,2-dichloroethane, and 1,1,2,2-tetrachloroethane.

The complexed gel of the present invention can be preferably used for the production of all-solid state secondary batteries and can be more preferably used for solid electrolyte compositions that are used for the production of all-solid state secondary batteries.

Part or all (preferably all) of the inorganic solid electrolyte_{gel} is preferably dissolved since all-solid state secondary batteries produced using a solid electrolyte composition containing the complexed gel of the present invention exhibit more favorable resistance and more favorable cycle characteristics.

This is assumed to result from the following reason.

That is, this is considered to be because, in the production of an electrode sheet, the application of the solid electrolyte composition forms a coated film in which gaps among individual particles (inorganic solid electrolyte particles, active material particles, auxiliary conductive agent particles, and the like) present in the electrode layers or the solid electrolyte layer are filled with the complexed gel, and the solvent_{gel} in the complexed gel is removed in the drying process of the coated film, thereby forming xerogel in which the gel and the respective particles such as the inorganic solid electrolyte particles twist together in three dimensions.

The complexed gel of the present invention may appropriately contain an appropriate amount of components other than the low-molecular-weight gellant_{gel}, the solvent_{gel}, and the inorganic solid electrolyte_{gel}, and examples of the other components include the additives such as the negative electrode active material, the positive electrode active material, the binder, the dispersant, the lithium salt, and the auxiliary conductive agent described in the section of the solid electrolyte composition.

For example, in a case in which the complexed gel of the present invention is used for a composition for an electrode that is a negative electrode or a positive electrode, it is also preferable to add a negative electrode active material or a positive electrode active material to the complexed gel of the present invention.

To the content ratio (mass ratio) among the components of the low-molecular-weight gellant_{gel}, the solvent_{gel}, and the inorganic solid electrolyte_{gel} in the complexed gel, the description of the content ratio (mass ratio) among the low-molecular-weight gellant, the inorganic solid electrolyte, and the solvent in the pre-liquid mixture a, the liquid mixture a, and the gel can be preferably applied. This is also true to the content ratio (mass) in a case in which the complexed gel contains components other than the inorganic solid electrolyte_{gel} and the low-molecular-weight gellant_{gel}.

<Method for Manufacturing Complexed Gel>

The complexed gel of the present invention is preferably manufactured using a method including Step (i-A) and (ii-Ai) in this order and Step (A),

Step (i-A): a step of heating a pre-liquid mixture Aa containing the low-molecular-weight gellant_{gel} and the solvent_{gel} and preparing a liquid mixture Aa in which the low-molecular-weight gellant_{gel} is dissolved,

Step (ii-A): a step of cooling the liquid mixture Aa and forming gel, and

Step (A): a step of adding the inorganic solid electrolyte_{gel} having conductivity of ions of metals belonging to Group I or II of the periodic table to the pre-liquid mixture Aa, the liquid mixture Aa, or the gel.

Here, the complexed gel may include an electrode active material, and the inorganic solid electrolyte_{gel} may be dispersed or dissolved in the complexed gel.

Specifically, the complexed gel of the present invention is more preferably manufactured using [α] a method including Steps (i-Aa), (i-Ab), and (ii-Ac) or [β] a method including Steps (i-Ac), (ii-Aa), and (ii-Ab).

[α]

Step (i-Aa): a step of heating a pre-liquid mixture Aa containing the low-molecular-weight gellant_{gel} and the solvent_{gel} and dissolving the low-molecular-weight gellant_{gel}.

Step (ii-Ab): a step of preparing a liquid mixture Aa which has the low-molecular-weight gellant_{gel} dissolved therein and contains the inorganic solid electrolyte_{gel} having conductivity of ions of metals belonging to Group I or II of the periodic table, and

Step (ii-Ac): a step of cooling the liquid mixture A and forming complexed gel.

Here, the liquid mixture A may include an electrode active material, and the inorganic solid electrolyte_{gel} may be dispersed or dissolved in the liquid mixture A.

[β]

Step (i-Ac): a step of heating a pre-liquid mixture Aa containing the low-molecular-weight gellant_{gel} and the solvent_{gel} and preparing a solution A in which the low-molecular-weight gellant_{gel} is dissolved,

Step (ii-Aa): a step of cooling the solution A and forming gel, and

Step (ii-Ab): a step of adding the inorganic solid electrolyte_{gel} having conductivity of ions of metals belonging to Group I or II of the periodic table to the gel and forming complexed gel.

Here, the complexed gel may include an electrode active material, and the inorganic solid electrolyte_{gel} may be dispersed or dissolved in the complexed gel.

To the low-molecular-weight gellant_{gel}, the solvent_{gel}, the inorganic solid electrolyte_{gel}, and other components and the content ratios among the respective components, the descriptions of the low-molecular-weight gellant_{gel}, the solvent_{gel}, the inorganic solid electrolyte_{gel}, and other components and the content ratios among the respective components in the above-described section of the complexed gel can be preferably applied respectively.

Examples of specific methods for preparing the liquid mixture A through Steps (i-Aa) and (i-Ab) include the following aspects.

Step (i-A1): a step of heating the pre-liquid mixture Aa containing the low-molecular-weight gellant_{gel} and the solvent_{gel} so as to dissolve the low-molecular-weight gellant_{gel}, then, further adding and mixing the inorganic solid electrolyte_{gel} thereinto so as to dissolve the low-molecular-weight gellant_{gel}, and preparing a mixture A containing the inorganic solid electrolyte_{gel}, and

Step (i-A2): a step of heating the pre-liquid mixture A containing the low-molecular-weight gellant_{gel}, the solvent_{gel}, and the inorganic solid electrolyte_{gel} so as to prepare the mixture A which has the low-molecular-weight gellant_{gel} dissolved therein and contains the inorganic solid electrolyte_{gel}.

All of the pre-liquid mixture and the liquid mixture can be mixed and prepared using arbitrary methods such as stirring and mechanical dispersion although the heating step is necessary. As the mechanical dispersion, the description of the mechanical dispersion method in the above-described section of i) the dissolution of the low-molecular-weight gellant and the dispersion of the gel can be preferably applied.

Part or all (preferably all) of the inorganic solid electrolyte_{gel} in the liquid mixture A or the inorganic solid electrolyte_{gel} in the complexed gel is preferably dissolved since all-solid state secondary batteries produced using a solid electrolyte composition containing complexed gel obtained using the manufacturing method of the present invention exhibit more favorable resistance and more favorable cycle characteristics. This is assumed to result from the same reason for the use of the solid electrolyte composition containing complexed gel in which part or all (preferably all) of the inorganic solid electrolyte_{gel} is dissolved.

Meanwhile, the form in which part or all (preferably all) of the inorganic solid electrolyte_{gel} is dissolved can be produced by adjusting the solvent_{gel}. In a case in which the above-described polar solvent_{gel} is used, it is possible to dissolve the inorganic solid electrolyte_{gel} in the complexed gel. Therefore, in the method of even in a case in which the inorganic solid electrolyte_{gel} is added to gel that has been produced in advance, the inorganic solid electrolyte_{gel} can be easily dissolved in the complexed gel.

In a case in which complexed gel containing additives such as a negative electrode active material and a positive electrode active material is manufactured, the additives may be mixed in any stages of the above-described steps. The additives are preferably mixed after the dissolution of the low-molecular-weight gellant_{gel} and more preferably mixed after the dissolution of the low-molecular-weight gellant_{gel} and the mixing and dispersion or dissolution of the inorganic solid electrolyte_{gel}.

The heating temperature in the step of dissolving the low-molecular-weight gellant_{gel} in the solvent_{gel} is not particularly limited as long as the low-molecular-weight gellant_{gel} is dissolved in the solvent_{gel}, but is preferably, for example, 40° C. to 200° C., more preferably 60° C. to 150° C., and still more preferably 80° C. to 120° C. from the viewpoint of the melting point of the gellant or the boiling point of the solvent.

The cooling step of forming the gel or the complexed gel is not particularly limited as long as the gel or the complexed gel is formed; however, from the viewpoint of the stability of the gel, the liquid mixture is preferably cooled from a range of 150° C. to 80° C. to a range of 50° C. to 0° C. for 0.1 hours to 24 hours and more preferably cooled from a range of 120° C. to 80° C. to a range of 40° C. to 20° C. for 0.1 hours to 5 hours.

During cooling, it is preferable to appropriately adjust the conditions to conditions under which desired gel or complexed gel is obtained. The liquid mixture or the solution may be left to stand or stirred and may be cooled using an arbitrary method or in the air. However, from the viewpoint of manufacturing aptitude, it is preferable to stir the liquid mixture or the solution.

All-solid state secondary batteries refer to secondary batteries having a positive electrode, a negative electrode, and a electrolyte which are all constituted of solid. In other words, all-solid state secondary batteries are differentiated from electrolytic solution-type secondary batteries in which a carbonate-based solvent is used as an electrolyte. Among these, the present invention is assumed to be an inorganic all-solid state secondary battery. All-solid state secondary batteries are classified into organic (high-molecular-weight) all-solid state secondary batteries in which a high-molecular-weight compound such as polyethylene oxide is used as an electrolyte and inorganic all-solid state secondary batteries in which the Li—P—S-based glass, LLT, LLZ or the like is used. Meanwhile, the application of high-molecular-weight compounds to inorganic all-solid state secondary batteries is not inhibited, and high-molecular-weight compounds can also be applied as binders of positive electrode active materials, negative electrode active materials, and inorganic solid electrolytes.

Inorganic solid electrolytes are differentiated from electrolytes in which the above-described high-molecular-weight compound is used as an ion conductive medium (high-molecular-weight electrolyte), and inorganic compounds serve as ion conductive media. Specific examples thereof include the Li—P—S glass, LLT, and LLZ. Inorganic solid electrolytes do not emit positive ions (Li ions) and exhibit an ion transportation function. In contrast, there are cases in which materials serving as an ion supply source which is added to electrolytic solutions or solid electrolyte layers and emits positive ions (Li ions) are referred to as electrolytes; however, in a case in which differentiated from electrolytes as the ion transportation materials, the materials are referred to as “electrolyte salts” or “supporting electrolytes”. Examples of the electrolyte salts include LiTFSI.

In the present invention, “compositions” refer to mixtures obtained by uniformly mixing two or more components. Here, compositions may partially include agglomeration or uneven distribution as long as the compositions substantially maintain uniformity and exhibit desired effects.

### EXAMPLES

Hereinafter, the present invention will be described in more detail on the basis of examples. Meanwhile, the present invention is not interpreted to be limited thereto. In the following examples, “parts” and “%” are mass-based unless particularly otherwise described. In addition, “room temperature” refers to 25° C.

<Synthesis of Low-Molecular-Weight Gellant>

### Synthesis Example of (A-1)

Octylamine (manufactured by Tokyo Chemical Industry Co., Ltd.) (26.5 g) was added to a 500 mL three-neck flask and was dissolved in tetrahydrofuran (200 mL). The solution was stirred on an ice bath and was cooled to a solution temperature of 5° C. Triethylamine (30 g) was added to the solution, and then a tetrahydrofuran solution (100 mL) of terephthalic acid chloride (manufactured by Wako Pure Chemical Industries, Ltd.) (20.3 g) was added dropwise thereto for one hour. The reaction solution was stirred for two hours at room temperature and then poured into 0.1 N hydrochloric acid water (1 L), the obtained solid was filtered and dried, thereby obtaining a low-molecular-weight gellant (A-1) (42.9 g). The melting point was 85° C.

### Synthesis Example of (A-3)

(1R,2R)-(−)-1,2-cyclohexanediamine (manufactured by Tokyo Chemical Industry Co., Ltd.) (4.0 g) was added to a 200 mL three-neck flask and was dissolved in tetrahydrofuran (100 mL). The solution was stirred on an ice bath and was cooled to a solution temperature of 5° C. Triethylamine (10.6 g) was added thereto, and then lauric acid chloride (manufactured by Tokyo Chemical Industry Co., Ltd.) (16.1 g) was added dropwise thereto for one hour. White solid was precipitated during the dropwise addition. The reaction solution was stirred for two hours at room temperature and then poured into 0.1 N hydrochloric acid water (1 L), the obtained solid was filtered, washed with methanol (50 mL), and dried, thereby obtaining a low-molecular-weight gellant (A-3) (18.3 g). The melting point was 122° C.

### Synthesis Example of (A-5)

(1R,2R)-(−)-1,2-cyclohexanediamine (manufactured by Tokyo Chemical Industry Co., Ltd.) (3.7 g) was added to a 200 ml three-neck flask and was dissolved in tetrahydrofuran (100 mL). The solution was stirred on an ice bath and was cooled to a solution temperature of 5° C. A tetrahydrofuran solution (50 mL) of dodecyl isocyanate (15.0 g) was added thereto for 30 minutes. White solid was precipitated during the dropwise addition. The reaction solution was stirred for five hours at room temperature, then, filtered, and washed with tetrahydrofuran (100 mL) cooled to 5° C., thereby obtaining a low-molecular-weight gellant (A-5) (15.1 g). The melting point was 153° C.

### Synthesis Example of (A-8)

L-isoleucine (manufactured by Tokyo Chemical industry Co., Ltd.) (13.1 g) and sodium hydroxide (5.8 g) were added to a 200 mL three-neck flask and were dissolved in N-methyl pyrrolidone (100 mL). Benzyl chloroformate (manufactured by Tokyo Chemical Industry Co., Ltd.) (17.1 g) was added dropwise thereto for one hour. The reaction solution was stirred for two hours at room temperature, and then solid obtained by adding 0.1 N hydrochloric acid water (1 L) was filtered and dried. The obtained solid (23.2 g) and N,N-dicylohexanecarbodiimde (22.9 g) were dissolved in dichloromethane (300 mL), and the solution temperature was cooled to 5° C. on an ice bath. Octadecylamine (25.6 g) was added dropwise thereto for one hour and stirred at room temperature for four hours. Solid generated as a byproduct was filtered and removed, and the filtrate was condensed. The obtained solid was recrystallized in acetonitrile, and the obtained crystals were dried, thereby obtaining a low-molecular-weight gellant (A-8) (38.6 g). The melting point was 132° C.

### Synthesis Example of (A-11)

L-isoleucine (manufactured by Tokyo Chemical Industry Co., Ltd.) (10.6 g) and sodium hydroxide (5.1 g) were added to a 200 mL three-neck flask and were dissolved in N-methyl pyrrolidone (100 mL). Octyl chloroformate (manufactured by Tokyo Chemical Industry Co., Ltd.) (26.5 g) was added dropwise thereto for one hour. The reaction solution was stirred for two hours at room temperature, and then solid obtained by adding 0.1 N hydrochloric acid water (1 L) was filtered and dried. The obtained solid (32.1 g) and N,N-dicylohexanecarbodiimde (20.1 g) were dissolved in dichloromethane (300 mL), and the solution temperature was cooled to 5° C. on an ice bath. Ethanediamine (4.8 g) was added dropwise thereto for one hour and stirred at room temperature for four hours. Solid generated as a byproduct was filtered and removed, and the filtrate was condensed. The obtained solid was recrystallized in acetonitrile, and the obtained crystals were dried, thereby obtaining a low-molecular-weight gellant (A-11) (25.1 g). The melting point was 172° C.

### Synthesis Example of (A-13)

A low-molecular-weight gellant (A-13) was synthesized using the method described in J. Chem. Soc., Chem. Commun., 1994, 11, 1401. The melting point was 139° C.

<Synthesis of Sulfide-Based Inorganic Solid Electrolyte>—Synthesis of Li—P—S-Based Glass—

As a sulfide-based inorganic solid electrolyte, Li—P—S-based glass was synthesized with reference to a non-patent document of T. Ohtomo, A. Hayashi, M. Tatsumisago, Y. Tsuchida, S. Hama, K. Kawamoto, Journal of Power Sources, 233, (2013), pp. 231 to 235 and A. Hayashi, S. Hama, H. Morimoto, M. Tatsumisago, T. Minami, Chem. Lett., (2001), pp. 872 and 873.

Specifically, in a globe box under an argon atmosphere (dew point: −70° C.), lithium sulfide (Li₂S, manufactured by Aldrich-Sigma, Co. LLC. Purity: >99.98%) (2.42 g) and diphosphorus pentasulfide (P₂S₅, manufactured by Aldrich-Sigma, Co. LLC. Purity: >99%) (3.90 g) were respectively weighed, injected into an agate mortar, and mixed using an agate muddler for five minutes. Meanwhile, the mixing ratio between Li₂S and P₂S₅ was set to 75:25 in terms of molar ratio.

66 zirconia beads having a diameter of 5 nm were injected into a 45 mL zirconia container (manufactured by Fritsch Japan Co., Ltd.), the full amount of the mixture of the lithium sulfide and the phosphorus pentasulfide was injected thereinto, and the container was completely sealed in an argon atmosphere. The container was set in a planetary ball mill P-7 (trade name) manufactured by Fritsch Japan Co., Ltd., mechanical milling was carried out at a temperature of 25° C. and a rotation speed of 510 rpm for 20 hours, thereby obtaining yellow powder (6.20 g) of a sulfide-based inorganic solid electrolyte (Li—P—S-based glass).

### Example 1 —Preparation of Solid Electrolyte Composition—

(1) Preparation of Solid Electrolyte Composition (K-1)

180 zirconia beads having a diameter of 5 mm were injected into a 45 mL zirconia container (manufactured by Fritsch Japan Co., Ltd.), and an inorganic solid electrolyte LLZ (Li₇La₃Zr₂O₁₂, lithium lanthanum zirconate, average particle diameter: 5.06 μm, manufactured by Toshima Manufacturing Co., Ltd.) (9.0 g), the low-molecular-weight gellant (A-1) (0.3 g), PVdF-HFP (polyvinylidene fluoride-hexatluoropropylene copolymer, manufactured by Arkema K. K., mass average molecular weight: 100,000) (0.3 g) as a binder, and toluene (15.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 500 rpm for two hours, thereby preparing a solid electrolyte composition (K-1).

(2) Preparation of Solid Electrolyte Composition (K-2)

180 zirconia beads having a diameter of 5 mm were injected into a 45 mL zirconia container (manufactured by Fritsch Japan Co., Ltd.), and the Li—P—S-based glass synthesized above (9.0 g), the low-molecular-weight gellant (A-1) (0.3 g), PVdF-HEP (0.3 g) as a binder, and heptane (15.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 500 rpm for two hours, thereby preparing a solid electrolyte composition (K-2).

(3) Manufacturing of Solid Electrolyte Compositions (K-3) to (K-8) and (HK-1) to (HK-3)

Solid electrolyte compositions (K-3) to (K-8) and (HK-1) to (HK-3) were manufactured using the same method as for the solid electrolyte compositions (K-1) and (K-2) except for the fact that the compositions were changed as shown in Table 1.

The compositions of the solid electrolyte compositions are summarized in Table 1.

Here, the solid electrolyte compositions (K-1) to (K-8) are the solid electrolyte composition of the present invention, and the solid electrolyte compositions (HK-1) to (HK-3) are comparative solid electrolyte compositions.

Meanwhile, n-octanediamine and 1,4-dibenzoylbutane do not form the self-assembled nanofibers and are thus not the low-molecular-weight gellant that is used in the present invention.

TABLE 1

| Solid | Additives | | Solid electrolyte | | Binder | | Dispersion medium | |
|---|---|---|---|---|---|---|---|---|
| electrolyte | | Parts by | | Parts by | | Parts by | | Parts by |
| composition | Kind | mass | Kind | mass | Kind | mass | Kind | mass |
| K-1 | A-1 | 0.3 | LLZ | 9.0 | C-1 | 0.3 | Toluene | 15.0 |
| K-2 | A-1 | 0.3 | Li—P—S | 9.0 | C-1 | 0.3 | Heptane | 15.0 |
| K-3 | A-3 | 0.3 | LLZ | 9.0 | — | — | Toluene | 15.0 |
| K-4 | A-3 | 0.3 | Li—P—S | 9.0 | — | — | Dibutylether | 15.0 |
| K-5 | A-5 | 0.2 | Li—P—S | 9.0 | — | — | Octane | 15.0 |
| K-6 | A-8 | 0.2 | Li—P—S | 9.0 | C-2 | 0.4 | Heptane | 15.0 |
| K-7 | A-11 | 0.2 | Li—P—S | 9.0 | C-3 | 0.4 | Toluene | 15.0 |
| K-8 | A-13 | 0.2 | Li—P—S | 9.0 | C-4 | 0.4 | Heptane | 15.0 |
| HK-1 | — | — | Li—P—S | 9.0 | C-1 | 0.3 | Heptane | 15.0 |
| HK-2 | n-Octanediamine | 0.3 | Li—P—S | 9.0 | C-2 | 0.3 | Heptane | 15.0 |
| HK-3 | 1,4-Dibenzoylbutane | 0.3 | Li—P—S | 9.0 | — | — | Heptane | 15.0 |

<Notes of table>
A-1, 3, 5, 8, 11, 13: Low-molecular-weight gellants synthesized above
LLZ: Li₇La₃Zr₂O₁₂ (lithium lanthanum zirconate, average particle diameter: 5.06 μm, manufactured by Toshima Manufacturing Co., Ltd.)
Li—P—S: Li—P—S-based glass synthesized above
C-1: Polyvinylidene fluoride-hexafluoropropylene copolymer (PVdF-HFP) manufactured by Arkema K.K., mass average molecular weight: 100,000
C-2: Styrene butadiene rubber (SBR) manufactured by Aldrich-Sigma, Co. LLC., mass average molecular weight: 150,000
C-3: Acrylic resin fine particles “Techpolymer MBX-5” (trade name, average particle diameter: 5 μm, manufactured by Sekisui Plastics Co., Ltd.)
C-4: Urethane-based resin fine particles “Daimicbeazs UCN-8070CM” (trade name, average particle diameter: 7 μm, manufactured by Dainichseika Color & Chemicals Mfg. Co., Ltd.)

—Preparation of Compositions for Positive Electrode—

(1) Preparation of Composition for Positive Electrode (U-1)

180 zirconia beads having a diameter of 5 mm were injected into a 45 mL zirconia container (manufactured by Fritsch Japan Co., Ltd.), and the Li—P—S-based glass synthesized above (2.7 g), the low-molecular-weight gellant (A-1) (0.3 g), PVdF-HFP (0.3 g) as a binder, and heptane (12.3 g) as a dispersion medium were injected thereinto. The container was set in a planetary ball mill P-7 (trade name) manufactured by Fritsch Japan Co., Ltd., the components were continuously mixed at a temperature of 25° C. and a rotation speed of 500 rpm for two hours, then, NMC (manufactured by Nippon Chemical Industrial Co., Ltd.) (7.0 g) was injected as an active material into the container, similarly, the container was set in the planetary ball mill P-7 (trade name), and the components were continuously mixed at a temperature of 25° C. and a rotation speed of 200 rpm for 15 minutes, thereby preparing a composition for a positive electrode (U-1).

(2) Preparation of Compositions for Positive Electrode (U-2) to (U-6) and (HU-1) and (HU-2)

Compositions tbr a positive electrode (U-2) to (U-6) and (HU-1) and (HU-2) were prepared using the same method for the composition for a positive electrode (U-1) except for the fact that the compositions were changed as shown in Table 2.

The compositions of the compositions for a positive electrode are summarised in Table 2.

Here, the compositions for a positive electrode (U-1) to (U-6) are the composition for a positive electrode of the present invention, and the compositions for a positive electrode (HU-1) and (HU-2) are comparative compositions for a positive electrode.

TABLE 2

| | | | | | | | Positive | | | |
|---|---|---|---|---|---|---|---|---|---|---|
| | | | Solid | | | | electrode active | | | |
| Composition | Additives | | electrolyte | | Binder | | material | | Dispersion medium | |
| for positive | | Parts by | | Parts by | | Parts by | | Parts by | | Parts by |
| electrode | Kind | mass | Kind | mass | Kind | mass | Kind | mass | Kind | mass |
| U-1 | A-1 | 0.3 | Li—P—S | 2.7 | C-1 | 0.3 | NMC | 7.0 | Heptane | 12.3 |
| U-2 | A-3 | 0.3 | Li—P—S | 2.7 | — | — | NMC | 7.0 | Heptane | 12.3 |
| U-3 | A-5 | 0.3 | Li—P—S | 2.7 | C-1 | 0.3 | LCO | 7.0 | Dibutylether | 12.3 |
| U-4 | A-8 | 0.3 | Li—P—S | 2.7 | C-2 | 0.3 | NMC | 7.0 | Octane | 12.3 |
| U-5 | A-11 | 0.3 | Li—P—S | 2.7 | C-3 | 0.3 | NMC | 7.0 | Heptane | 12.3 |
| U-6 | A-13 | 0.3 | Li—P—S | 2.7 | C-4 | 0.3 | NMC | 7.0 | Heptane | 12.3 |
| HU-1 | — | — | Li—P—S | 2.7 | C-2 | 0.3 | NMC | 7.0 | Heptane | 12.3 |
| HU-2 | n-Octanediamine | 0.3 | Li—P—S | 2.7 | C-1 | 0.3 | NMC | 7.0 | Heptane | 12.3 |

<Notes of table>
LCO: LiCoO₂, lithium cobaltate
NMC: LiNi_{0.33}Mn_{0.33}Co_{0.33}O₂, lithium nickel manganese cobalt oxide

—Preparation of Compositions for Negative Electrode—

(1) Preparation of Composition for Negative Electrode (S-1)

180 zirconia beads having a diameter of 5 mm were injected into a 45 mL zirconia container (manufactured by Fritsch Japan Co., Ltd.), and the Li—P—S-based glass synthesized above (5.0 g), the low-molecular-weight gellant (A-1) (0.5 g), and heptane (12.3 g) as a dispersion medium were injected thereinto. The container was set in a planetary ball mill P-7 (trade name) manufactured by Fritsch Japan Co., Ltd., mechanical dispersion was continued at a temperature of 25° C. and a rotation speed of 500 rpm for two hours, then, acetylene black (7.0 g) was injected into the container, similarly, the container was set in the planetary ball mill P-7 (trade name), and the components were continuously mixed at a temperature of 25° C. and a rotation speed of 100 rpm for 15 minutes, thereby preparing a composition for a negative electrode (S-1).

(3) Preparation of Compositions for Negative Electrode (S-2) to (S-6) and (HS-1) and (HS-2)

Compositions for a negative electrode (S-2) to (S-6) and (HS-1) and (HS-2) were prepared using the same method for the composition for a negative electrode (S-1) except for the fact that the compositions were changed as shown in Table 3.

The compositions of the compositions for a negative electrode are summarized in Table 3.

Here, the compositions for a negative electrode (S-1) to (S-6) are the composition for a negative electrode of the present invention, and the compositions for a negative electrode (HS-1) and (HS-2) are comparative compositions for a negative electrode.

TABLE 3

| | | | | | | | Negative | | | |
|---|---|---|---|---|---|---|---|---|---|---|
| | | | | | | | electrode | | | |
| Composition | Additives | | Solid electrolyte | | Binder | | active material | | Dispersion medium | |
| for negative | | Parts by | | Parts by | | Parts by | | Parts by | | Parts by |
| electrode | Kind | mass | Kind | mass | Kind | mass | Kind | mass | Kind | mass |
| S-1 | A-1 | 0.5 | Li—P—S | 5.0 | — | — | AB | 7.0 | Heptane | 12.3 |
| S-2 | A-3 | 0.5 | Li—P—S | 5.0 | — | — | AB | 7.0 | Heptane | 12.3 |
| S-3 | A-5 | 0.5 | Li—P—S | 5.0 | — | — | AB | 7.0 | Heptane | 12.3 |
| S-4 | A-8 | 0.5 | Li—P—S | 5.0 | C-1 | 0.2 | AB | 7.0 | Heptane | 12.3 |
| S-5 | A-11 | 0.5 | Li—P—S | 5.0 | C-3 | 0.2 | AB | 7.0 | Dibutylether | 12.3 |
| S-6 | A-13 | 0.5 | Li—P—S | 5.0 | C-4 | 0.2 | AB | 7.0 | Octane | 12.3 |
| HS-1 | — | — | Li—P—S | 5.0 | C-2 | 0.2 | AB | 7.0 | Heptane | 12.3 |
| HS-2 | 1,4-Dibenzoylbutane | 0.5 | Li—P—S | 5.0 | — | — | AB | 7.0 | Heptane | 12.3 |

<Notes of table>
AB: Acetylene black

—Production of Positive Electrode Sheet for Secondary Battery—

The composition for a positive electrode prepared above was applied onto a 20 μm-thick aluminum foil using an applicator having an adjustable clearance and then left to stand at room temperature for one hour, thereby gelatinizing the applied composition for a positive electrode. The composition was heated at 60° C. for two hours, and the dispersion medium was dried, thereby obtaining a positive electrode sheet for a secondary battery.

—Manufacturing of Electrode Sheets for All-Solid State Secondary Battery and All-Solid State Secondary Batteries—

The solid electrolyte composition prepared above was applied onto the positive electrode sheet for a secondary battery manufactured above using an applicator having an adjustable clearance and then left to stand at room temperature for one hour, thereby gelatinizing the applied solid electrolyte composition. The composition was heated at 60° C. for two hours, thereby drying the applied solvent. After that, the composition for a negative electrode prepared above was further applied onto the dried solid electrolyte composition and then left to stand at room temperature for one hour, thereby gelatinizing the applied composition for a negative electrode. After that, the composition was heated at 60° C. for two hours so as to dry the dispersion medium, thereby producing an electrode sheet for an all-solid state secondary battery. A 20 μm-thick copper foil was overlaid on a negative electrode active material layer in the sheet and pressurized (at 300 MPa for one minute) using a pressing machine so as to obtain an arbitrary density, thereby manufacturing Test Nos. 101 to 110 and c11 to c14 of all-solid state secondary batteries shown in Table 4.

The all-solid state secondary batteries have the layer constitution of FIG. 1 and have a laminate structure of the copper foil/the negative electrode active material layer/a solid electrolyte layer/the positive electrode sheet for a secondary battery (a positive electrode active material layer/the aluminum foil). A positive electrode layer, a negative electrode layer, and the solid electrolyte layer were produced so as to have film thicknesses of 120 μm, 50 μm, and 100 μm respectively and were prepared so that the film thicknesses varied in a range of the above-described film thickness-±10% in all of the all-solid state secondary batteries.

### Testing Example 1

A disc-shaped piece having a diameter of 14.5 mm was cut out from an all-solid state secondary battery 15 manufactured above, put into a 2032-type stainless steel coin case 14 into which a spacer and a washer were combined, and a confining pressure (a screw-fastening pressure: 8 N) was applied from the outside of the coin case 14 using a testing body illustrated in FIG. 2, thereby manufacturing a coin battery 13 for testing. Meanwhile, in FIG. 2, reference sign 11 indicates an upper portion-supporting plate, reference sign 12 indicates a lower portion-supporting plate, and reference sign S indicates a spring.

<Evaluation>

On the coin battery 13 manufactured above, the following evaluations were carried out.

<Evaluation of Battery Voltage>

The battery voltage of the coin battery manufactured above (all-solid state secondary battery) was measured using a charging and discharging evaluation device “TOSCAT-3000 (trade name)” manufactured by Toyo System Co., Ltd.

The coin battery was charged at a current density of 2 A/m² until the battery voltage reached 4.2 V, and, once the battery voltage reached 4.2 V, the coin battery was charged with constant voltage until the current density reached less than 0.2 A/m². The coin battery was discharged at a current density of 2 A/m² until the battery voltage reached 3.0 V. The above-described process was considered as one cycle, and the battery voltage after a 5 mAh/g discharging in the third cycle was read and evaluated using the following standards. Meanwhile, the evaluation rankings of “C” or higher are the passing levels of the present testing.

(Evaluation Standards)

A: 4.1 V or more

B: 4.0 V or more and less than 4.1 V

C: 3.9 V or more and less than 4.0 V

D: 3.8 V or more and less than 3.9 V

E: Less than 3.8 V

<Evaluation of Cycle Characteristics>

The cycle characteristics of the all-solid state secondary battery manufactured above were measured using a charging and discharging evaluation device “TOSCAT-3000 (trade name)” manufactured by Toyo System Co., Ltd.

The all-solid state secondary battery was charged and discharged under the same conditions as those in the battery voltage evaluation. The discharge capacity in the third cycle was considered as 100, and the cycle characteristics were evaluated using the following standards from the number of times of the cycle when the discharge capacity reached less than 80. Meanwhile, the evaluation rankings of “C” or higher are the passing levels of the present testing.

(Evaluation Standards)

A: 50 times or more

B: 40 times or more and less than 50 times

C: 30 times or more and less than 40 times

D: 20 times or more and less than 30 times

E: Less than 20 times

The constitutions and evaluation results of the electrode sheets for an all-solid state secondary battery and the all-solid state secondary batteries are summarized in Table 4. Here, Test Nos. 101 to 110 are electrode sheets for an all-solid state secondary battery and all-solid state secondary batteries in which the low-molecular-weight gellant that is used in the present invention was used, and Test Nos. c11 to c14 are comparative electrode sheets for an all-solid state secondary battery and comparative all-solid state secondary batteries.

Meanwhile, in Table 4, battery voltage is abbreviated as voltage.

TABLE 4

| | Composition for | | Composition for | Battery evaluation | | |
|---|---|---|---|---|---|---|
| | positive | Solid electrolyte | negative | | Cycle | |
| Test No. | electrode | composition | electrode | Voltage | characteristics | Note |
| 101 | U-1 | K-2 | S-1 | C | C | Present Invention |
| 102 | U-2 | K-2 | S-2 | C | B | Present Invention |
| 103 | U-3 | K-4 | S-3 | B | C | Present Invention |
| 104 | U-4 | K-4 | S-4 | B | B | Present Invention |
| 105 | U-5 | K-5 | S-5 | A | B | Present Invention |
| 106 | U-6 | K-6 | S-6 | B | A | Present Invention |
| 107 | U-2 | K-7 | S-5 | A | B | Present Invention |
| 108 | U-4 | K-8 | S-5 | A | A | Present Invention |
| 109 | U-6 | K-7 | S-6 | A | A | Present Invention |
| 110 | U-5 | K-8 | S-6 | A | A | Present Invention |
| c11 | HU-1 | HK-1 | HS-1 | C | E | Comparative |
| | | | | | | Example |
| c12 | HU-2 | HK-2 | HS-2 | E | D | Comparative |
| | | | | | | Example |
| c13 | HU-1 | HK-3 | HS-2 | E | D | Comparative |
| | | | | | | Example |
| c14 | HU-1 | HK-2 | HS-1 | C | E | Comparative |
| | | | | | | Example |

As is clear from Table 4, it is found that the all-solid state secondary batteries of Test Nos. 101 to 110 in which the low-molecular-weight gellant that is used in the present invention was used suppressed resistance and had favorable cycle characteristics.

In contrast, the comparative all-solid state secondary battery of test No. c11 produced using the composition for a positive electrode, the solid electrolyte composition, and the composition for a negative electrode which did not contain any additives had poor and insufficient cycle characteristics. In addition, the comparative all-solid state secondary battery of Test No. c14 in which the additives that did not form self-assembled nanofibers were used for the solid electrolyte composition had insufficient cycle characteristics, and the comparative all-solid state secondary battery of Test No. c12 in which the additives that did not form any self-assembled nanofibers were used in all of the composition for a positive electrode, the solid electrolyte composition, and the composition for a negative electrode and the comparative all-solid state secondary battery of Test No. c13 in which the additives that did not form any self-assembled nanofibers were used in the solid electrolyte composition and the composition for a negative electrode were unsatisfactory in terms of both the suppression of resistance and cycle characteristics.

### Example 2

<Production of Gel>

Production of Gel (Z-1)

One gram of the low-molecular-weight gellant (A-3) was weighed in a 100 mL three-neck flask, toluene (49.0 g) was added thereto, and the components were heated and dissolved at 100° C. In the case of being cooled in the air at room temperature (25° C.) for three hours, the solution was gelatinized, thereby obtaining gel (Z-1).

Production of Gel (Z-2)

One gram of the low-molecular-weight gellant (A-3) was weighed in a 100 mL three-neck flask, dehydrated heptane (47.0 g) was added thereto, and the components were heated and dissolved at 100° C. in an argon atmosphere. The sulfide-based inorganic solid electrolyte (Li—P—S-based glass) (2.0 g) synthesized above was added thereto, and furthermore, the components were continuously heated and stirred for one hour. In the case of being cooled in the air at room temperature (25° C.) for three hours under stirring, the dispersion solution of the sulfide-based inorganic solid electrolyte was gelatinized, thereby obtaining gel (Z-2).

Production of Gel (Z-3)

One gram of the low-molecular-weight gellant (A-3) was weighed in a 100 mL three-neck flask, dehydrated N,N-dimethylformamide (47.0 g) was added thereto, and the components were heated and dissolved at 100° C. in an argon atmosphere. The sulfide-based inorganic solid electrolyte (Li—P—S-based glass) (2.0 g) synthesized above was added thereto, and the solid electrolyte was dissolved. The liquid mixture turned into a yellowish transparent solution. In the case of being cooled in the air at room temperature (25° C.) for three hours under stirring, the yellow solution of the sulfide-based inorganic solid electrolyte was gelatinized, thereby obtaining gel (Z-3).

Production of Gel (Z-4)

One gram of the low-molecular-weight gellant (A-3) was weighed in a 100 mL three-neck flask, dehydrated xylene (46.0 g) was added thereto, and the components were heated and dissolved at 100° C. in an argon atmosphere. The sulfide-based inorganic solid electrolyte (Li—P—S-based glass) (1.0 g) synthesized above and NMC (manufactured by Nippon Chemical Industrial Co., Ltd.) (2.0 g), as an active material for a positive electrode, were added thereto, and furthermore, the components were continuously heated and stirred for one hour. In the case of being cooled in the air at room temperature (25° C.) for three hours under stirring, the dispersion solution of the sulfide-based inorganic solid electrolyte and the positive electrode active material was gelatinized, thereby obtaining gel (Z-4).

Production of Gel (Z-5)

One gram of the low-molecular-weight gellant (A-3) was weighed in a 100 mL three-neck flask, dehydrated N-methylformaide (46.0 g) was added thereto, and the components were heated and dissolved at 100° C. in an argon atmosphere. The sulfide-based inorganic solid electrolyte (Li—P—S-based glass) (1.0 g) synthesized above was added thereto and dissolved, thereby producing a yellow transparent solution. Subsequently, acetylene black (2.0 g) was added as an active material for a negative electrode, and furthermore, the components were continuously heated and stirred for one hour. In the case of being cooled in the air at room temperature (25° C.) for three hours under stirring, the dispersion solution of the sulfide-based inorganic solid electrolyte and the negative electrode active material was gelatinized, thereby obtaining gel (Z-5).

The compositions of the gel are summarized in Table 5.

Here, the gel (Z-2) to (Z-5) are the complexed gel of the present invention.

TABLE 5

| | Additives | | Solid electrolyte | | Active material | | Solvent | |
|---|---|---|---|---|---|---|---|---|
| | | Parts by | | Parts by | | Parts by | | Parts by |
| Gel | Kind | mass | Kind | mass | Kind | mass | Kind | mass |
| Z-1 | A-3 | 1.0 | — | — | — | — | Toluene | 49.0 |
| Z-2 | A-3 | 1.0 | Li—P—S | 2.0 | — | — | Dehydrated heptane | 47.0 |
| Z-3 | A-3 | 1.0 | Li—P—S | 2.0 | — | — | Dehydrated | 47.0 |
| | | | | | | | N,N-dimethylformamide | |
| Z-4 | A-3 | 1.0 | Li—P—S | 1.0 | NMC | 2.0 | Dehydrated xylene | 46.0 |
| Z-5 | A-3 | 1.0 | Li—P—S | 1.0 | AB | 2.0 | Dehydrated N-methylformamide | 46.0 |

<Notes of table>
A-3: Low-molecular-weight gellant synthesized above
Li—P—S: Li—P—S-based glass synthesized above
NMC: LiNi_{0.33}Mn_{0.33}Co_{0.33}O₂, lithium nickel manganese cobalt oxide
AB: Acetylene black

—Preparation of Solid Electrolyte Compositions—

(1) Preparation of solid electrolyte composition (K-9)

180 Teflon (registered trademark) beads having a diameter of 5 mm were injected into a 45 mL zirconia container (manufactured by Fritsch Japan Co., Ltd.), and the Li—P—S-based glass synthesized above (9.0 g), the gel (Z-2) (15.0 g), PVdF-HEP (0.3 g) as a binder, and toluene (5.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 150 rpm for two hours, thereby preparing a solid electrolyte composition (K-9).

(2) Preparation of Solid Electrolyte Composition (K-10)

180 Teflon (registered trademark) beads having a diameter of 5 mm were injected into a 45 mL zirconia container (manufactured by Fritsch Japan Co., Ltd.), and the Li—P—S-based glass synthesized above (9.0 g), the gel (Z-3) (15.0 g), PVdF-HEP (0.3 g) as a binder, and toluene (5.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 150 rpm for two hours, thereby preparing a solid electrolyte composition (K-10).

(3) Preparation of Solid Electrolyte Composition (K-11)

180 Teflon (registered trademark) beads having a diameter of 5 mm were injected into a 45 mL zirconia container (manufactured by Fritsch Japan Co., Ltd.), and the Li—P—S-based glass synthesized above (9.0 g), the gel (Z-1) (15.0 g), and toluene (5.0 g) as a dispersion medium were injected thereinto. After that, the container was set in a planetary ball mill P-7 (trade name) manufactured by Fritsch Japan Co., Ltd., the components were continuously stirred at a temperature of 25° C. and a rotation speed of 150 rpm for two hours, thereby preparing a solid electrolyte composition (K-11).

—Preparation of Compositions for Positive Electrode—

(1) Preparation of Composition for Positive Electrode (U-7)

180 Teflon (registered trademark) beads having a diameter of 5 mm were injected into a 45 mL zirconia container (manufactured by Fritsch Japan Co., Ltd.), and the Li—P—S-based glass synthesized above (2.7 g), the gel (Z-4) (15.0 g), PVdF-HFP (0.3 g) as a binder, and heptane (2.0 g) as a dispersion medium were injected thereinto. The container was set in a planetary ball mill P-7 (trade name) manufactured by Fritsch Japan Co., Ltd., the components were continuously mixed at a temperature of 25° C. and a rotation speed of 150 rpm for two hours, then, NMC (manufactured by Nippon Chemical Industrial Co., Ltd.) (7.0 g) was injected as an active material into the container, similarly, the container was set in the planetary ball mill P-7 (trade name), and the components were continuously mixed at a temperature of 25° C. and a rotation speed of 150 rpm for 15 minutes, thereby preparing a composition for a positive electrode (U-7).

—Preparation of Compositions for Negative Electrode—

(1) Preparation of Composition for Negative Electrode (S-7)

180 Teflon (registered trademark) beads having a diameter of 5 mm were injected into a 45 mL zirconia container (manufactured by Fritsch Japan Co., Ltd.), and the Li—P—S-based glass synthesized above (5.0 g), the gel (Z-5) (15.0 g), and heptane (3.0 g) as a dispersion medium were injected thereinto. The container was set in a planetary ball mill P-7 (trade name) manufactured by Fritsch Japan Co., Ltd., the components were continuously mixed at a temperature of 25° C. and a rotation speed of 150 rpm for two hours, then, acetylene black (7.0 g) was injected into the container, similarly, the container was set in the planetary ball mill P-7 (trade name), and the components were continuously mixed at a temperature of 25° C. and a rotation speed of 100 rpm for 15 minutes, thereby preparing a composition for a negative electrode (S-7).

The compositions of the solid electrolyte compositions, the compositions for a positive electrode, and the compositions for a negative electrode are summarized in Table 6.

Here, the solid electrolyte compositions (K-9) to (K-11) are the solid electrolyte composition of the present invention, the composition for a positive electrode (U-7) is the composition for a positive electrode of the present invention, and the composition for a negative electrode (S-7) is the composition for a negative electrode of the present invention.

TABLE 6

| | | Gel | | | | | | | | | |
|---|---|---|---|---|---|---|---|---|---|---|---|
| | | | | | | Solid | | Active | | | |
| | | | | Gellant | | electrolyte | | material | | Solvent | |
| | | | Parts by | | Parts by | | Parts by | | Parts by | | Parts by |
| Composition | | Kind | mass | Kind | mass | Kind | mass | Kind | mass | Kind | mass |
| Solid | K-9 | Z-2 | 15.0 | A-3 | 0.3 | Li—P—S | 0.6 | — | — | Heptane | 14.1 |
| electrolyte | K-10 | Z-3 | 15.0 | A-3 | 0.3 | Li—P—S | 0.6 | — | — | Dehydrated | 14.1 |
| | | | | | | | | | | N,N-dimethylformamide | |
| | K-11 | Z-1 | 15.0 | A-3 | 0.3 | — | — | — | — | Dehydrated toluene | 14.7 |
| For | U-7 | Z-4 | 15.0 | A-4 | 0.3 | Li—P—S | 0.3 | NMC | 0.6 | Dehydrated xylene | 13.8 |
| positive | | | | | | | | | | | |
| electrode | | | | | | | | | | | |
| For | S-7 | Z-5 | 15.0 | A-5 | 0.3 | Li—P—S | 0.3 | AB | 0.6 | Dehydrated | 13.8 |
| negative | | | | | | | | | | N-methylformamide | |
| electrode | | | | | | | | | | | |

| | | | | | | Active | | Dispersion | |
|---|---|---|---|---|---|---|---|---|---|
| | | Solid electrolyte | | Binder | | material | | medium | |
| | | | Parts by | | Parts by | | Parts by | | Parts by |
| Composition | | Kind | mass | Kind | mass | Kind | mass | Kind | mass |
| Solid | K-9 | Li—P—S | 9.0 | C-1 | 0.3 | — | — | Toluene | 5.0 |
| electrolyte | K-10 | Li—P—S | 9.0 | C-1 | 0.3 | — | — | Toluene | 5.0 |
| | K-11 | Li—P—S | 9.0 | — | — | — | — | Toluene | 5.0 |
| For | U-7 | Li—P—S | 2.7 | C-1 | 0.3 | NMC | 7.0 | Heptane | 2.0 |
| positive | | | | | | | | | |
| electrode | | | | | | | | | |
| For | S-7 | Li—P—S | 5.0 | — | — | AB | 7.0 | Heptane | 3.0 |
| negative | | | | | | | | | |
| electrode | | | | | | | | | |

<Notes of table>
Z-1 to Z-5: Gel produced above
A-3: Low-molecular-weight gellant synthesized above
Li—P—S: Li—P—S-based glass synthesized above
NMC: LiNi_{0.33}Mn_{0.33}Co_{0.33}O₂, lithium nickel manganese cobalt oxide
AB: Acetylene black
C-1: Polyvinylidene fluoride-hexafluoropropylene copolymer (PVdF-HFP) manufactured by Arkema K.K., mass average molecular weight: 100,000

<Manufacturing of Positive Electrode Sheets for Secondary Battery and All-Solid State Secondary Batteries>

All-solid state secondary batteries of Test Nos. 111 to 115 shown in Table 7 were manufactured in the same manner as in Example 1 except for the fact that the compositions for a positive electrode, the solid electrolyte compositions, and the compositions for a negative electrode shown in Table 7 were used.

The all-solid state secondary batteries manufactured above have the layer constitution of FIG. 1.

### Testing Example 2

Coin batteries 13 for testing were produced in the same manner as in Example 1 using the obtained all-solid state secondary batteries.

<Evaluation>

The coin batteries 13 for testing manufactured above were evaluated in the same manner as in Example 1.

The constitutions and the evaluation results of the electrode sheets for an all-solid state secondary battery and the all-solid state secondary batteries are summarized in Table 7.

Here, Test Nos. 111 to 115 are electrode sheets for an all-solid state secondary battery and all-solid state secondary batteries in which the low-molecular-weight gellant that is used in the present invention was used.

Meanwhile, in Table 7, battery voltage is abbreviated as voltage.

TABLE 7

| | Composition for | | Composition for | Battery evaluation | | |
|---|---|---|---|---|---|---|
| | positive | Solid electrolyte | negative | | Cycle | |
| Test No. | electrode | composition | electrode | Voltage | characteristics | Note |
| 111 | U-7 | K-9 | S-2 | A | A | Present |
| | | | | | | Invention |
| 112 | U-2 | K-10 | S-7 | A | A | Present |
| | | | | | | Invention |
| 113 | U-7 | K-9 | S-7 | A | A | Present |
| | | | | | | Invention |
| 114 | U-7 | K-10 | S-7 | A | A | Present |
| | | | | | | Invention |
| 115 | U-7 | K-11 | S-7 | A | A | Present |
| | | | | | | Invention |

As is clear from Table 7, it is found that the all-solid state secondary batteries of Test Nos. 111 to 115 in which the solid electrolyte composition containing the complexed gel of the present invention was used were all excellent in terms of the suppression of resistance and the improvement of cycle characteristics.

The present invention has been described together with the embodiment; however, unless particularly specified, the present inventors do not intend to limit the present invention to any detailed portion of the description and consider that the present invention is supposed to be broadly interpreted within the concept and scope of the present invention described in the claims.

1: negative electrode collector

2: negative electrode active material layer

3: solid electrolyte layer

4: positive electrode active material layer

5: positive electrode collector

6: operation portion

10: all-solid state secondary battery

11: upper portion-supporting plate

12: lower portion-supporting plate

13: coin battery

14: coin case

15: all-solid state secondary battery

S: screw

What is claimed is:

1. A solid electrolyte composition comprising:
a low-molecular-weight gellant;
an inorganic solid electrolyte having conductivity of ions of metals belonging to Group I or II of the periodic table; and
a dispersion medium.

2. The solid electrolyte composition according to claim 1,
wherein the low-molecular-weight gellant includes a compound which has a molecular weight of 300 or more and less than 1,000 and has an alkyl group having 8 or more carbon atoms and a partial structure represented by Formula (1), 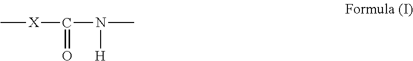
in Formula (I), X represents any one of a single bond, an oxygen atom, and NH.

3. The solid electrolyte composition according to claim 2,
wherein the low-molecular-weight gellant includes a compound which has two or more partial structures represented by Formula (I) and has one or more alkyl groups having 8 or more carbon atoms.

4. The solid electrolyte composition according to claim 1,
wherein the low-molecular-weight gellant includes a compound which has an alkyl group having 8 or more carbon atoms in a molecular terminal.

5. The solid electrolyte composition according to claim 1,
wherein a melting point of the low-molecular-weight gellant is 80° C. or higher.

6. The solid electrolyte composition according to claim 1,
wherein the low-molecular-weight gellant includes an optically active compound.

7. The solid electrolyte composition according to claim 2,
wherein the partial structure represented by Formula (I) is represented by any one of Formulae (I-1) and (I-2).

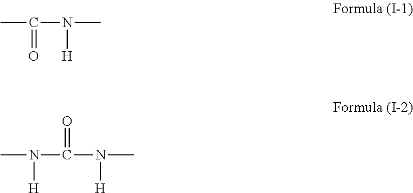

8. The solid electrolyte composition according to claim 1,
wherein the low-molecular-weight gellant includes at least one compound represented by any one of Formulae (1) to (4), 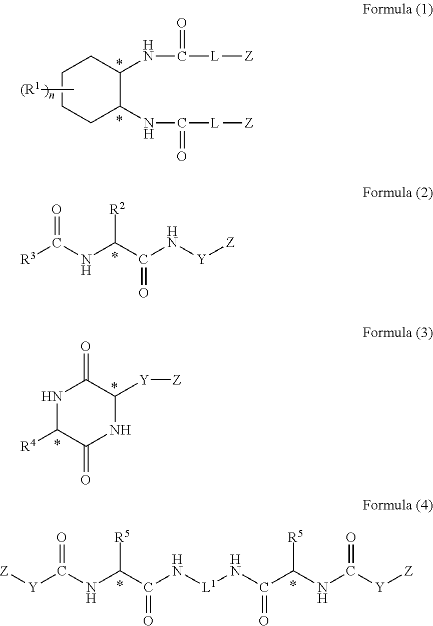
in Formulae (1) to (4), R¹ represents a monovalent organic group, n represents an integer of 0 to 8, R² represents a monovalent organic group, R³ represents a monovalent organic group or —Y—Z, R⁴ represents a monovalent organic group, R⁵ represents a monovalent organic group, L represents any group of a single bond, an oxygen atom, and NH, Y represents a single bond or a divalent linking group, Z represents an alkyl group having 8 or more carbon atoms, L¹ represents a divalent linking group, and * represents an optically active carbon atom.

9. The solid electrolyte composition according to claim 8,
wherein, in Formulae (1) to (4), the alkyl group having 8 or more carbon atoms represented by Z has a radical-polymerizable or cationic-polymerizable functional group.

10. The solid electrolyte composition according to claim 1,
wherein the inorganic solid electrolyte having conductivity of ions of metals belonging to Group I or II of the periodic table is a sulfide-based inorganic solid electrolyte.

11. The solid electrolyte composition according to claim 1,
wherein part or all of the inorganic solid electrolyte having conductivity of ions of metals belonging to Group I or II of the periodic table is dissolved.

12. The solid electrolyte composition according to claim 1,
wherein 0.1 to 20 parts by mass of the low-molecular-weight gellant is contained with respect to 100 parts by mass of the inorganic solid electrolyte.

13. The solid electrolyte composition according to claim 1,
wherein the dispersion medium is a hydrocarbon-based solvent.

14. The solid electrolyte composition according to claim 1, further comprising:
a binder.

15. The solid electrolyte composition according to claim 14,
wherein the binder is polymer particles having an average particle diameter of 0.05 μm to 20 μm.

16. A mixture for the solid electrolyte composition according to claim 1, the mixture comprising:
an inorganic solid electrolyte having conductivity of ions of metals belonging to Group I or II of the periodic table;
a dispersion medium; and
gel,
wherein the gel includes at least a low-molecular-weight gellant and a solvent,
the gel may include a second inorganic solid electrolyte having conductivity of ions metals belonging to Group I or II of the periodic table and/or an electrode active material, and
the second inorganic solid electrolyte may be dispersed or dissolved in the gel.

17. A method for manufacturing a solid electrolyte composition, comprising:
mixing the mixture for a solid electrolyte composition according to claim 16.

18. A method for manufacturing a solid electrolyte composition, the method comprising Steps (i) to (iii):
Step (i): a step of heating a pre-liquid mixture a containing a low-molecular-weight gellant and a solvent and preparing a liquid mixture a in which the low-molecular-weight gellant is dissolved;
Step (ii): a step of cooling the liquid mixture a and forming gel; and
Step (iii): a step of mixing the gel, a first inorganic solid electrolyte having conductivity of ions of metals belonging to Group I or II of the periodic table, and a dispersion medium and preparing a solid electrolyte composition,
wherein a step of adding a second inorganic solid electrolyte having conductivity of ions of metals belonging to Group I or II of the periodic table and/or an electrode active material to the pre-liquid mixture a, the liquid mixture a, or the gel may be included, and
the second inorganic solid electrolyte may be dispersed or dissolved in the gel.

19. A method for manufacturing an electrode sheet for an all-solid state secondary battery, the method comprising:
applying the solid electrolyte composition according to claim 1 onto a metal foil;
gelatinizing the solid electrolyte composition; and
forming a film.

20. An electrode sheet for an all-solid state secondary battery comprising in order:
a positive electrode active material layer;
a solid electrolyte layer; and
a negative electrode active material layer,
wherein at least one of the positive electrode active material layer, the solid electrolyte layer, and the negative electrode active material layer contains a low-molecular-weight gellant and an inorganic solid electrolyte having conductivity of ions of metals belonging to Group I or II of the periodic table.

21. An all-solid state secondary battery constituted using the electrode sheet for an all-solid state secondary battery according to claim 20.

22. A method for manufacturing an all-solid state secondary battery,
wherein an all-solid state secondary battery having a positive electrode active material layer, a solid electrolyte layer, and a negative electrode active material layer in this order is manufactured through the manufacturing method according to claim 19.

23. Complexed gel comprising:
a low-molecular-weight gellant;
a solvent; and
an inorganic solid electrolyte having conductivity of ions of metals belonging to Group I or II of the periodic table,
wherein the inorganic solid electrolyte may be dispersed or dissolved in the complexed gel.

24. A method for manufacturing the complexed gel according to claim 23, the method comprising Steps (i-A) and (ii-Ai) in this order and Step (A):
Step (i-A): a step of heating a pre-liquid mixture Aa containing the low-molecular-weight gellant and the solvent and preparing a liquid mixture Aa in which the low-molecular-weight gellant is dissolved;
Step (ii-A): a step of cooling the liquid mixture Aa and forming gel; and
Step (A): a step of adding an inorganic solid electrolyte having conductivity of ions of metals belonging to Group I or II of the periodic table to the pre-liquid mixture Aa, the liquid mixture Aa, or the gel,
wherein the complexed gel may include an electrode active material, and
the inorganic solid electrolyte may be dispersed or dissolved in the complexed gel.
